(19) United States
(12) Patent Application Publication
(10) Pub. No.: US 2026/0046897 A1
(43) Pub. Date: Feb. 12, 2026

(54) METHOD AND APPARATUS USED IN NODE FOR WIRELESS COMMUNICATION

(71) Applicant: SHANGHAI LANGBO COMMUNICATION TECHNOLOGY COMPANY LIMITED, Minhang District, Shanghai (CN)

(72) Inventors: Jin LIU, Shanghai (CN); Xiaobo ZHANG, Shanghai (CN)

(21) Appl. No.: 19/101,054

(22) PCT Filed: Aug. 7, 2023
(86) PCT No.: PCT/CN2023/111367

§ 371 Date: Feb. 4, 2025

(30) Foreign Application Priority Data
Aug. 10, 2022 (CN) 202210961211.6

(51) Int. Cl. H04W 72/25; H04W 64/00

(52) U.S. Cl. CPC H04W 72/25; H04W 64/00

(57) ABSTRACT

Disclosed in the present application are a method and apparatus used in a node for wireless communication. The method comprises: a first node sending first control information and a first signal, wherein the first control information comprises at least one of a source identification domain and a destination identification domain, the source identification domain being used for indicating the first node, and the destination identification domain being used for indicating a target receiver of the first signal; and whether the first control information is borne on a first PSCCH or on a first PSSCH is related to the first signal. The present application effectively implements the resource allocation and indication of SL PRSes and SL data, and improves the utilization rate of effective resources.

### RELATED APPLICATIONS

This application is a National Stage under 35 USC 371 of and claims priority to International Application No. PCT/CN2023/111367, filed Aug. 7, 2023, which claims the priority benefit of CN application Ser. No. 20/221,0961211.6, filed Aug. 10, 2022.

### TECHNICAL FIELD

This application relates to a transmission method and apparatus in a wireless communications system, and in particular, to a sidelink-related transmission solution and apparatus in wireless communications.

### BACKGROUND

Starting from Long Term Evolution (LTE), 3 GPP (3rd Generation Partner Project) has evolved SL (Sidelink, sidelink) as a direct communication mode between a user and a user, and a first NR SL (New Radio Sidelink, New Radio Sidelink) standard of “5G V2X with NR Sidelink” is completed in Rel-16 (Release-16, Release 16). In Rel-16, NR SL is mainly designed for V2X (Vehicle-to-Everything, Internet of Vehicles), but it can also be used for public safety. With the further enhancement of NR SL, Rel-17 introduces periodic-based partial sensing (PBPS), continuous partial sensing (CPS), random selection and discontinuous reception (DRX) power saving schemes, and also introduces inter-UE coordination schemes to provide more reliable channel resources.

In order to meet commercialized application scenarios, the industry has proposed new requirements, higher data throughput, and support for new carrier frequencies for V2X. Therefore, on the 3 GPP RAN-#94 E conference, the standardized work of NR V2X Rel-18 is formally turned on through work item description (WID) RP-213678 for NR SL evolution.

### SUMMARY OF THE INVENTION

According to the work plan in RP 213588, NR Rel-18 needs to support an enhanced positioning technology of sidelink positioning (SL positioning), where the mainstream sidelink positioning technology includes SL RTT technology, SL AOA, SL TDOA, SL AOD, etc. and the execution of these technologies needs to rely on measurement of SL PRS (sidelink positioning reference signal). The transmission parameter information of the SL PRS is greatly different from the traditional SL data, and the configuration, activation, invalidation and triggering of the SL PRS cannot be met by directly referring to existing sidelink control information (SCI).

In view of the foregoing problem, this application discloses a signaling indication method for an SL PRS, to implement an effective configuration of an SL PRS resource. It should be noted that, in the case of no conflict, the embodiments in the user equipment and the features in the embodiments of the present disclosure may be applied to the base station, and vice versa. In the case of no conflict, the embodiments of the present disclosure and the features in the embodiments may be arbitrarily combined with each other. Further, although the beginner of the present application is for SL, the present application can also be used for UL (Uplink, uplink). Further, although the primary party of the present application is for single-carrier communication, the present application can also be used for multi-carrier communication. Further, although the primary party of the present application is for single antenna communication, the present application can also be used for multi-antenna communication. Further, although the beginner of the present application is directed to a V2X scenario, the present application is also applicable to a communication scenario between a terminal and a base station, a terminal and a relay, and between a relay and a base station, to obtain a similar technical effect in a V2X scenario. In addition, using a unified solution in different scenarios (including but not limited to a V2X scenario and a communication scenario between a terminal and a base station) helps to reduce hardware complexity and costs.

It should be noted that the explanation of terminology in this application is defined with reference to the 3 GPP specification protocol TS36 series, the TS37 series, and the TS38 series, but can also refer to the definition of the specification protocol of the Institute of Electrical and Electronics Engineers (IEEE).

The present application discloses a method in a first node for wireless communication, comprising:
Sending first control information and a first signal;
The first control information includes at least one of a source identifier field and a destination identifier field, the source identifier field is used to indicate the first node, the destination identifier field is used to indicate a target receiver of the first signal, and the first control information is carried on a first PSCCH or a first PSSCH related to the first signal.

In one embodiment, the problem to be solved by the present application is: existing SCI cannot satisfy configuration, activation, invalidation, and triggering of an SL PRS.

In one embodiment, the method of the present disclosure is to introduce a new resource allocation and indication method for an SL PRS.

In one embodiment, the method of the present application is to establish a relationship between a channel carried by first control information and a first signal.

In one embodiment, the method of the present disclosure is to suggest a relationship between the first control information and the first positioning reference signal.

In one embodiment, the above method has the advantage of effectively implementing resource allocation and indication of SL PRS and SL data, and improving the utilization rate of effective resources.

According to an aspect of this application, the foregoing method is characterized in that whether the first control information includes a first field is related to the first signal, the first field is used to indicate that the first signal is a first positioning reference signal, or the first field is used to indicate a format of the first control information.

According to one aspect of the present disclosure, the above method is characterized in that whether the first control information is carried on the first PSCCH is related to whether the first signal is a first positioning reference signal.

According to one aspect of the present disclosure, the above method is characterized in that the first signal is the first positioning reference signal, and the first control information is carried on the first PSCCH; or the first signal is first data, and the first control information is carried on the first PSSCH.

According to one aspect of the present disclosure, the above method is characterized in that the first signal is a first positioning reference signal, whether the first control information is carried on the first PSCCH is related to a type of the first positioning reference signal, and a candidate of the type of the first positioning reference signal includes a first positioning type and a second positioning type.

According to one aspect of the present disclosure, the above method is characterized in that the type of the first positioning reference signal is the first positioning type, and the first control information is carried on the first PSCCH; or the type of the first positioning reference signal is the second positioning type, and the first control information is carried on the first PSSCH.

According to one aspect of the present disclosure, the above method is characterized in that the first positioning type and the second positioning type are respectively associated with two different time-frequency maps of the first positioning reference signal.

According to one aspect of the present disclosure, the above method is characterized in that the type of the first positioning reference signal is the first positioning type, and a time-frequency resource occupied by the first positioning reference signal and a time-frequency resource occupied by the first control information share the same resource pool; alternatively, the type of the first positioning reference signal is the second positioning type, and a time-frequency resource occupied by the first positioning reference signal and a time-frequency resource occupied by the first control information respectively belong to different resource pools.

According to one aspect of the present disclosure, the above method is characterized by comprising:
receiving a second positioning reference signal on a target time-frequency resource block; and
the type of the first positioning reference signal is the second positioning type, and the first positioning reference signal is associated with the second positioning reference signal.

According to one aspect of the present disclosure, the above method is characterized in that whether the first control information indicates that a time-frequency resource occupied by the first signal is related to the first signal.

According to an aspect of this application, the foregoing method is characterized in that the first signal is the first positioning reference signal, and the first control information indicates a time-frequency resource occupied by the first signal; or the first signal is the first data, the first control information is not used to indicate a time-frequency resource occupied by the first signal, and the second control information is used to indicate a time-frequency resource occupied by the first signal.

According to one aspect of the present disclosure, the above method is characterized in that the first signal is the first positioning reference signal; the type of the first positioning reference signal is the first positioning type, the first control information indicates a time-frequency resource occupied by the first signal, or the type of the first positioning reference signal is the second positioning type, the first control information is not used to indicate a time-frequency resource occupied by the first signal, and the second control information is used to indicate a time-frequency resource occupied by the first signal.

According to one aspect of the present disclosure, the above method is characterized in that the first node is a user equipment (UE).

According to one aspect of the present disclosure, the above method is characterized in that the first node is a relay node.

According to one aspect of the present disclosure, the above method is characterized in that the first node is a roadside device (RSU).

The present application discloses a method in a second node for wireless communication, comprising:
receiving first control information and a first signal;
The first control information includes at least one of a source identifier field and a destination identifier field, the source identifier field is used to indicate the first node, the destination identifier field is used to indicate a target receiver of the first signal, and the first control information is carried on a first PSCCH or a first PSSCH related to the first signal.

According to an aspect of this application, the foregoing method is characterized in that whether the first control information includes a first field is related to the first signal, the first field is used to indicate that the first signal is a first positioning reference signal, or the first field is used to indicate a format of the first control information.

According to one aspect of the present disclosure, the above method is characterized in that whether the first control information is carried on the first PSCCH is related to whether the first signal is a first positioning reference signal.

According to one aspect of the present disclosure, the above method is characterized in that the first signal is the first positioning reference signal, and the first control information is carried on the first PSCCH; or the first signal is first data, and the first control information is carried on the first PSSCH.

According to one aspect of the present disclosure, the above method is characterized in that the first signal is a first positioning reference signal, whether the first control information is carried on the first PSCCH is related to a type of the first positioning reference signal, and a candidate of the type of the first positioning reference signal includes a first positioning type and a second positioning type.

According to one aspect of the present disclosure, the above method is characterized in that the type of the first positioning reference signal is the first positioning type, and the first control information is carried on the first PSCCH; or the type of the first positioning reference signal is the second positioning type, and the first control information is carried on the first PSSCH.

According to one aspect of the present disclosure, the above method is characterized in that the first positioning type and the second positioning type are respectively associated with two different time-frequency maps of the first positioning reference signal.

According to one aspect of the present disclosure, the above method is characterized in that the type of the first positioning reference signal is the first positioning type, and a time-frequency resource occupied by the first positioning reference signal and a time-frequency resource occupied by the first control information share the same resource pool; alternatively, the type of the first positioning reference signal is the second positioning type, and a time-frequency resource occupied by the first positioning reference signal and a time-frequency resource occupied by the first control information respectively belong to different resource pools.

According to one aspect of the present disclosure, the above method is characterized by comprising:
sending a second positioning reference signal on a target time-frequency resource block; and
the type of the first positioning reference signal is the second positioning type, and the first positioning reference signal is associated with the second positioning reference signal.

According to one aspect of the present disclosure, the above method is characterized in that whether the first control information indicates that a time-frequency resource occupied by the first signal is related to the first signal.

According to an aspect of this application, the foregoing method is characterized in that the first signal is the first positioning reference signal, and the first control information indicates a time-frequency resource occupied by the first signal; or the first signal is the first data, the first control information is not used to indicate a time-frequency resource occupied by the first signal, and the second control information is used to indicate a time-frequency resource occupied by the first signal.

According to one aspect of the present disclosure, the above method is characterized in that the first signal is the first positioning reference signal; the type of the first positioning reference signal is the first positioning type, the first control information indicates a time-frequency resource occupied by the first signal, or the type of the first positioning reference signal is the second positioning type, the first control information is not used to indicate a time-frequency resource occupied by the first signal, and the second control information is used to indicate a time-frequency resource occupied by the first signal.

According to one aspect of the present disclosure, the above method is characterized in that the second node is a user equipment.

According to one aspect of the present disclosure, the above method is characterized in that the second node is a relay node.

According to one aspect of the present disclosure, the above method is characterized in that the second node is a roadside device.

The present application discloses a first node for wireless communication, comprising:
a first transmitter, configured to send first control information and a first signal;

The first control information includes at least one of a source identifier field and a destination identifier field, the source identifier field is used to indicate the first node, the destination identifier field is used to indicate a target receiver of the first signal, and the first control information is carried on a first PSCCH or a first PSSCH related to the first signal.

The present application discloses a second node for wireless communication, comprising:
a second receiver, configured to receive first control information and a first signal;
The first control information includes at least one of a source identifier field and a destination identifier field, the source identifier field is used to indicate the first node, the destination identifier field is used to indicate a target receiver of the first signal, and the first control information is carried on a first PSCCH or a first PSSCH related to the first signal.

In one embodiment, the present application has the following advantages:

The problem to be solved by the present application is that the existing SCI cannot satisfy the configuration, activation, invalidation and triggering of the SL PRS.

The present application introduces a new resource allocation and indication method for SL PRS.

In this application, a relationship between a channel carried on the first control information and the first signal is established.

In this application, the first control information and the first positioning reference signal are recommended.

In this application, resource allocation and indication of SL PRS and SL data are effectively implemented, to improve utilization of effective resources.

### BRIEF DESCRIPTION OF THE DRAWINGS

Other features, objects, and advantages of the present disclosure will become more apparent upon reading the detailed description of non-limiting embodiments with reference to the following drawings:

FIG. 1 illustrates a flowchart of processing a first node according to an embodiment of the present disclosure;

FIG. 2 is a schematic diagram of a network architecture according to an embodiment of this application;

FIG. 3 illustrates a schematic diagram of a radio protocol architecture of a user plane and a control plane according to an embodiment of the present disclosure;

FIG. 4 illustrates a schematic diagram of a first communication device and a second communication device according to one embodiment of the present disclosure;

FIG. 5 illustrates a flowchart of wireless signal transmission according to an embodiment of the present disclosure;

FIG. 6 illustrates a schematic diagram of a relationship between first control information and a first signal according to one embodiment of the present disclosure;

FIG. 7 illustrates a schematic diagram of a relationship between first control information and a first signal according to one embodiment of the present disclosure;

FIG. 8 illustrates a schematic diagram of a relationship between first control information, a first domain and a first signal according to one embodiment of the present disclosure;

FIG. 9 illustrates a structural block diagram of a processing apparatus in a first node according to an embodiment of the present disclosure;

FIG. 10 shows a structural block diagram of a processing apparatus in a second node according to an embodiment of the present disclosure.

### DETAILED DESCRIPTION OF THE EMBODIMENTS

The technical solutions of the present application will be further described in detail below with reference to the accompanying drawings, and it should be noted that, in the case of no conflict, the embodiments of the present application and the features in the embodiments may be arbitrarily combined with each other.

### Example 1

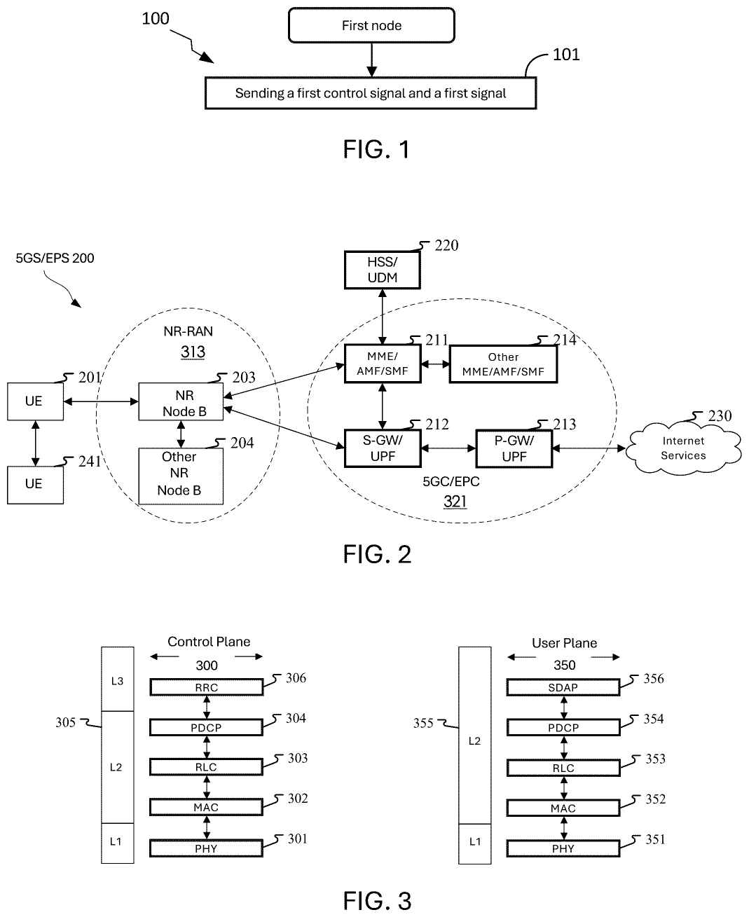

Embodiment 1 illustrates a flowchart of processing a first node according to an embodiment of this application, as shown in FIG. 1. In FIG. 1, each block represents a step.

In Embodiment 1, the first node in this application performs step 101, and sends first control information and a first signal, where the first control information includes at least one of a source identifier field and a destination identifier field, the source identifier field is used to indicate the first node, and the destination identifier field is used to indicate a target receiver of the first signal; and the first control information is carried on a first PSCCH or a first PSSCH related to the first signal.

In one embodiment, the first PSCCH is a Physical Sidelink Control Channel (PSCCH).

In one embodiment, the first PSCCH occupies at least one multicarrier symbol in a time domain.

In one embodiment, a time-domain resource occupied by the first PSCCH belongs to a slot, and the one slot comprises a plurality of multicarrier symbols.

In one embodiment, the first PSCCH occupies at least one multicarrier symbol in a time slot in a time domain.

In one embodiment, the first PSCCH occupies a plurality of subcarriers in a frequency domain.

In one embodiment, the first PSCCH occupies at least one Physical Resource Block (PRB) in a frequency domain, and the one physical resource block comprises a plurality of subcarriers.

In one embodiment, the first PSCCH occupies at least one subchannel in a frequency domain, and the one subchannel comprises at least one physical resource block.

In one embodiment, a frequency-domain resource occupied by the first PSCCH belongs to a sub-channel, and the one sub-channel comprises at least one physical resource block.

In one embodiment, the first PSCCH occupies at least one physical resource block in a subchannel in a frequency domain.

In one embodiment, the first PSCCH occupies a plurality of multicarrier symbols in a time domain, and the first PSCCH occupies a plurality of physical resource blocks in a frequency domain.

In one embodiment, the first PSCCH is used for SL (Sidelink) transmission or communication.

In one embodiment, the first PSCCH is used to carry SCI (Sidelink Control Information).

In one embodiment, the first PSCCH carries first-stage SCI.

In one embodiment, the first PSSCH is a Physical Sidelink Shared Channel (PSSCH).

In one embodiment, the first PSSCH occupies at least one multicarrier symbol in a time domain.

In one embodiment, time-domain resources occupied by the first PSSCH belong to one slot.

In one embodiment, the first PSSCH occupies a plurality of multicarrier symbols in a time slot in a time domain.

In one embodiment, the first PSSCH occupies a plurality of subcarriers in a frequency domain.

In one embodiment, the first PSSCH occupies at least one physical resource block in a frequency domain.

In one embodiment, the first PSSCH occupies at least one subchannel in a frequency domain.

In one embodiment, a frequency-domain resource occupied by the first PSSCH belongs to a subchannel.

In one embodiment, the first PSSCH occupies a plurality of multicarrier symbols in a time domain, and the first PSSCH occupies at least one subchannel in a frequency domain.

In one embodiment, the first PSSCH is used for SL transmission or communication.

In one embodiment, the first PSSCH is used to carry an SL-SCH.

In one embodiment, the first PSSCH is used to carry SCI and SL-SCH.

In one embodiment, the first PSSCH carries second-stage SCI.

In one embodiment, any multicarrier symbol occupied by the first PSCCH in time domain is an Orthogonal Frequency Division Multiplexing (OFDM) symbol.

In one embodiment, any multicarrier symbol occupied by the first PSCCH in time domain is a Single-Carrier Frequency Division Multiple Access (SC-FDMA) symbol.

In one embodiment, any multicarrier symbol occupied by the first PSCCH in time domain is a Discrete Fourier Transform Spread Orthogonal Frequency Division Multiplexing (DFT-S-OFDM) symbol.

In one embodiment, any multicarrier symbol occupied by the first PSCCH in time domain is a Frequency Division Multiple Access (FDMA) symbol.

In one embodiment, any multicarrier symbol occupied by the first PSCCH in time domain is a Filter Bank Multi-Carrier (FBMC) symbol.

In one embodiment, any multicarrier symbol occupied by the first PSCCH in time domain is an Interleaved Frequency Division Multiple Access (IFDMA) symbol.

In one embodiment, any multicarrier symbol occupied by the first PSSCH in time domain is an OFDM symbol.

In one embodiment, any multicarrier symbol occupied by the first PSSCH in time domain is an SC-FDMA symbol.

In one embodiment, any multicarrier symbol occupied by the first PSSCH in time domain is a DFT-S-OFDM symbol.

In one embodiment, any multicarrier symbol occupied by the first PSSCH in time domain is an FDMA symbol.

In one embodiment, any multicarrier symbol occupied by the first PSSCH in a time domain is an FBMC symbol.

In one embodiment, any multicarrier symbol occupied by the first PSSCH in time domain is an IFDMA symbol.

In one embodiment, the first control information is a first-stage SCI (1st-Stage Sidelink Control Information, first-stage sidelink control information).

In one embodiment, the definition of the first-stage SCI refers to section 8.3 of 3 GPP TS 38.212.

In one embodiment, the first control information is a second-stage SCI (2nd-Stage Sidelink Control Information, second-stage sidelink control information).

In one embodiment, the definition of the second-stage SCI refers to section 8.4 of 3 GPP TS 38.212.

In one embodiment, the first control information is used to transport sidelink scheduling information.

In one embodiment, the first control information is used for transmitting Inter-UE Coordination Related Information.

In one embodiment, the first control information is used for transmitting sidelink positioning related information.

In one embodiment, the first control information is used for transmitting sidelink positioning reference signal related information.

In one embodiment, the first control information is used to indicate the first signal.

In one embodiment, the first control information is used for scheduling the first signal.

In one embodiment, the first control information is used to indicate a time-domain resource occupied by the first signal.

In one embodiment, the first control information is used to indicate a time-frequency resource occupied by the first signal.

In one embodiment, the first control information is used to determine a time-frequency resource occupied by the first signal.

In one embodiment, the first control information is used to indicate a time-frequency spectrum of the first signal.

In one embodiment, the first control information is used to indicate a resource pool to which a time-frequency resource occupied by the first signal belongs.

In one embodiment, the first control information is used to determine a resource pool to which a time-frequency resource occupied by the first signal belongs.

In one embodiment, the first control information is used to indicate a source identifier and a destination identifier of the first signal.

In one embodiment, the first control information is carried on one of the first PSCCH or the first PSSCH.

In one embodiment, the first control information is carried on the first PSCCH.

In one embodiment, the first control information is carried on the first PSSCH.

In one embodiment, the first control information is carried on the first PSCCH or is carried on the first PSSCH related to the first signal.

In one embodiment, the first signal is used to determine whether the first control information is carried on the first PSCCH or the first PSSCH.

In one embodiment, a format of the first control information is SCI format 1-B (SCI Format 1-B).

In one embodiment, a format of the first control information is one of SCI format 2-A (SCI Format 2-A), SCI format 2-B (SCI Format 2-B), and SCI format 2-C (SCI Format 2-C).

In one embodiment, the format of the first control information is one of SCI format 1-B, SCI format 2-A, SCI format 2-B, and SCI format 2-C.

In one embodiment, the format of the first control information is SCI format 2-A.

In one embodiment, the format of the first control information is SCI format 2-B.

In one embodiment, the format of the first control information is SCI format 2-C.

In one embodiment, a candidate of the format of the first control information comprises an SCI format 2-A, an SCI format 2-B, and an SCI format 2-C.

In one embodiment, a candidate of the format of the first control information comprises an SCI format 1-B, an SCI format 2-A, an SCI format 2-B, and an SCI format 2-C.

In one embodiment, the first control information comprises at least one of a source identification field and a destination identification field.

In one embodiment, the first control information comprises the source identification field.

In one embodiment, the first control information comprises the destination identification field.

In one embodiment, the first control information comprises the source identification field and the destination identification field.

In one embodiment, the first control information comprises the source identification field, and the first control information does not comprise the destination identification field.

In one embodiment, the first control information comprises the destination identification field, and the first control information does not comprise the source identification field.

In one embodiment, the source identification field is used to indicate a Source ID (Source ID).

In one embodiment, the source identification field is used to indicate the first node.

In one embodiment, the source identification field is used to indicate a sender of the first control information.

In one embodiment, the source identification field is used to indicate a sender of the first signal.

In one embodiment, the source identification field comprises a positive integer number of bits.

In one embodiment, the source identification field comprises 8 bits.

In one embodiment, the destination identifier field is used to indicate a Destination ID (Destination ID).

In one embodiment, the destination identifier field is used to indicate a target receiver of the first control information.

In one embodiment, the destination identification field is used to indicate a target receiver of the first signal.

In one embodiment, the destination identifier comprises a positive integer number of bits.

In one embodiment, the destination identifier comprises 16 bits.

In one embodiment, the first signal is one of a first positioning reference signal or first data.

In one embodiment, the first signal is the first positioning reference signal.

In one embodiment, the first signal is the first data.

In one embodiment, the first signal is a first positioning reference signal, a type of the first positioning reference signal is a first positioning type, or a type of the first positioning reference signal is a second positioning type.

### Example 2

Embodiment 2 illustrates a schematic diagram of a network architecture according to the present disclosure, as shown in FIG. 2. FIG. 2 illustrates a diagram of a network architecture 200 of 5G NR, Long-Term Evolution (LTE) and Long-Term Evolution Advanced (LTE-A) systems. The 5G NR or LTE network architecture 200 May be referred to as a 5 GS (5G System)/Evolved Packet System (EPS) 200 some other suitable terminology. The 5 GS EPS 200 May include one or more User Equipment (UE) 201, a UE 241 for sidelink communication with the UE 201, an NG-RAN (Next Generation Radio Access Network) 202, a 5 GC (5G Core Network, 5G Core Network)/EPC (Evolved Packet Core) 210, an HSS (Home Subscriber Server)/UDM (Unified Data Management) 220, and an Internet service 230 The 5 GS EPS may be interconnected with other access networks, but these entities/interfaces are not shown for simplicity. As shown, 5 GS EPS provides packet-switched services, however, those skilled in the art will readily appreciate that the various concepts presented throughout this application may be extended to networks or other cellular networks that provide circuit-switched services. The NG-RAN includes an NR Node B (G 1) 203 and other GDUs 204 The graceful 203 provides termination of the user and control plane protocol towards the UE 201. The graceful 203 May be connected to other GDUs 204 via an Xn interface (e.g. backhaul) The GRUB 203 May also be referred to as a base station, a base transceiver station, a radio base station, a radio transceiver, a transceiver function, a basic service set (BSS), an extended service set (ESS), a TRP (transmit receive node), or some other suitable terminology. In an NTN network, an example of a gNB 203 includes a satellite, an aircraft, or a terrestrial base station relayed through a satellite. The gNB 203 provides the UE 201 with an access point to the 5 GC/EPC 210. Examples of UE 201 include cellular telephones, smart phones, session initiation protocol (SIP) phones, laptop computers, personal digital assistants (PDAs), satellite radios, non-terrestrial base station communications, satellite mobile communications, global positioning systems, multimedia devices, video devices, digital audio players (e.g. MP3 players), cameras, game consoles, unmanned aerial vehicles, aircraft, narrowband Internet of Things devices, machine type communications devices, land vehicles, automobiles, wearable devices, or any other similar functional device. A person skilled in the art may also refer to UE 201 as a mobile station, subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terminology. The gNB 203 is connected to the 5 GC/EPC 210.5 GC/EPC 210 through an S1/NG interface, and includes an MME (Mobility Management Entity)/AMF (Authentication Management Field)/SMF (Session Management Function) 211, another MME/AMF/SMF 214, an S-GW (Service Gateway)/UPF (User Plane Function) 212, and a P-GW (Packet Date Network Gateway)/UPF 213 MME/AMF/SMF 211 are control nodes for processing signaling between the UE 201 and the 5 GC/EPC 210. Generally, the MME/AMF/SMF 211 provides bearer and connection management. All User IP (Internet Protocol) packets are transmitted through the S-GW/UPF 212, and the S-GW/UPF 212 itself is connected to the P-GW/UPF 213 P-GW to provide UE IP address allocation and other functions. The P-GW/UPF 213 is connected to the Internet service 230, which includes an Internet Protocol service corresponding to the operator, and may specifically include the Internet, an intranet, an IP Multimedia Subsystem (IMS), and a packet-switched streaming service.

In one embodiment, a first node in the present disclosure comprises the UE 201.

In one embodiment, a second node in the present disclosure comprises the UE 241.

In one embodiment, a user equipment in the present disclosure includes the UE 201.

In one embodiment, the user equipment in the present disclosure includes the UE 241.

In one embodiment, a relay node in the present disclosure includes the UE 201.

In one embodiment, a relay node in the present disclosure includes the UE 241.

In one embodiment, a roadside device in the present disclosure includes the UE 201.

In one embodiment, a roadside device in the present disclosure includes the UE 241.

In one embodiment, a transmitter of first control information in the present disclosure includes the UE 201.

In one embodiment, a receiver of the first control information in the present disclosure includes the UE 241.

In one embodiment, a transmitter of a first signal in the present disclosure includes the UE 201.

In one embodiment, a receiver of a first signal in the present disclosure includes the UE 241.

In one embodiment, a transmitter of second control information in the present disclosure includes the UE 201.

In one embodiment, a receiver of second control information in the present disclosure includes the UE 241.

In one embodiment, a transmitter of a second positioning reference signal in the present disclosure includes the UE 241.

In one embodiment, a receiver of a second positioning reference signal in the present disclosure includes the UE 201.

### Example 3

Embodiment 3 shows a schematic diagram of an embodiment of a radio protocol architecture of a user plane and a control plane according to the present disclosure, as shown in FIG. 3. FIG. 3 is a schematic diagram illustrating an embodiment of a radio protocol architecture for a user plane 350 and a control plane 300, and FIG. 3 shows, with three layers, a radio protocol architecture for a first node device (RSU, on-board device or in-vehicle communication module in a UE or V2X) and a second node device (RSU, on-board device, or on-board communication module in V2X), or a control plane 300 between two UEs: layer 1, layer 2, and layer 3 Layer 1 (L1 layer) is the lowest layer and performs various PHY (physical layer) signal processing functions. The L1 layer will be referred to herein as PHY 301 layer 2 (L2 layer) 305 over PHY 301, and is responsible for the link between the first node device and the second node device and between the two UEs through PHY 301. The L2 layer 305 includes a Medium Access Control (MAC) sublayer 302, a Radio Link Control (RLC) sublayer 303, and a Packet Data Convergence Protocol (PDCP) sublayer 304. The PDCP sublayer 304 provides data encryption and integrity protection, and the PDCP sublayer 304 further provides handover support of the first node device to the second node device. The RLC sublayer 303 provides segmentation and reassembly of data packets, retransmission of a lost data packet is achieved through ARQ, and the RLC sublayer 303 further provides repeated data packet detection and protocol error detection. The MAC sublayer 302 provides the multiplexing of mapping and logical channels between the logical and transport channels. The MAC sublayer 302 is also responsible for allocating various radio resources (e.g. resource blocks) in a cell between the first node devices. The MAC sublayer 302 is also responsible for HARQ operations. The RRC sublayer 306 in the layer 3 (L3 layer) in the control plane 300 is responsible for obtaining radio resources (i.e. radio bearers) and configuring the lower layer using RRC signaling between the second node device and the first node device. The radio protocol architecture of the user plane 350 includes a layer 1 (L1 layer) and a layer 2 (L2 layer) in which the radio protocol architecture for the first node device and the second node device is substantially the same for the PDCP sublayer 354 in the physical layer 351, the L2 layer 355, and the MAC sublayer 352 in the L2 layer 355 and the corresponding layer and sublayer in the control plane 300, but the PDCP sublayer 354 also provides header compression for the upper layer packet to reduce wireless transmission overhead. The L2 layer 355 in the user plane 350 further includes a Service Data Adaptation Protocol (SDAP) sublayer 356, and the SDAP sublayer 356 is responsible for mapping between a QoS flow and a data radio bearer (DRB) to support service diversity. Although not shown, a first node device may have several upper layers above L2 layer 355, including a network layer (e.g. an IP layer) terminating at a P-GW on a network side and an application layer terminating at another end of the connection (e.g. remote UE, server, etc.).

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the first signal in the present disclosure is generated by the PHY 301.

In one embodiment, the first signal in the present disclosure is generated by the RRC sublayer 306.

In one embodiment, the first signal in the present disclosure is transmitted to the PHY 301 via the MAC sublayer 302.

In one embodiment, the first control information in the present disclosure is generated by the PHY 301.

In one embodiment, the first control information in the present disclosure is generated by the MAC sublayer 302.

In one embodiment, the first control information in the present disclosure is transmitted to the PHY 301 via the MAC sublayer 302.

In one embodiment, the second control information in the present disclosure is generated by the PHY 301.

In one embodiment, the second control information in the present disclosure is generated by the MAC sublayer 302.

In one embodiment, the second control information in the present disclosure is transmitted to the PHY 301 via the MAC sublayer 302.

In one embodiment, the second positioning reference signal in the present disclosure is generated by the PHY 301.

### Example 4

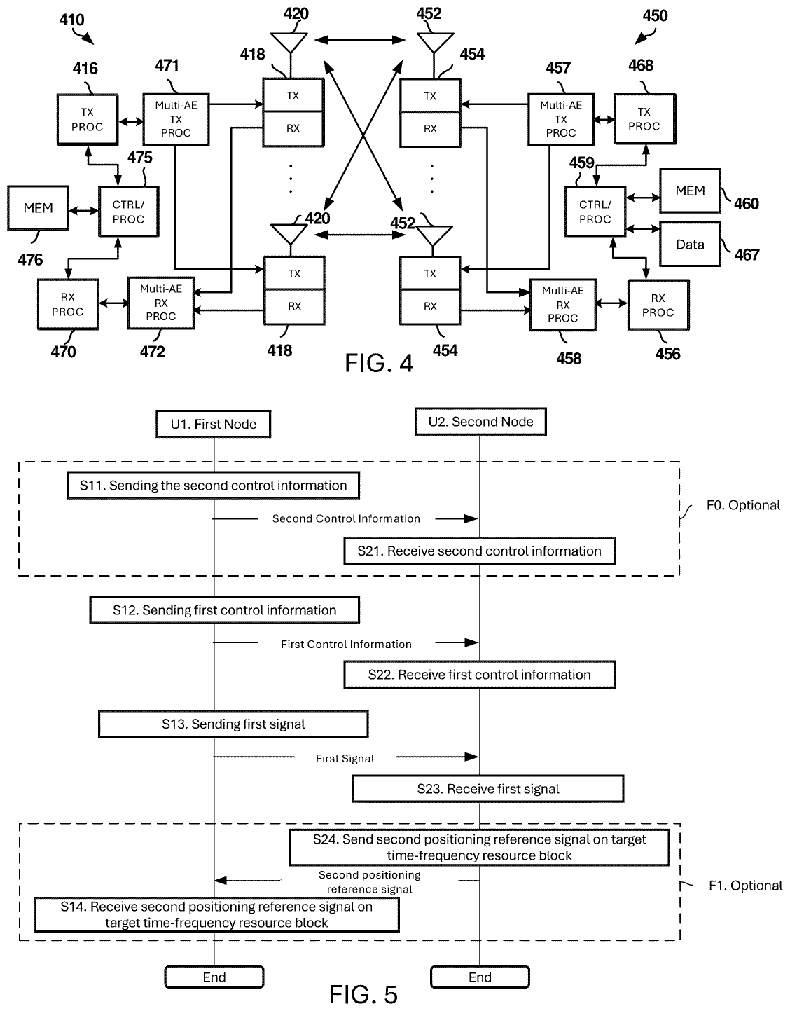

Embodiment 4 shows a schematic diagram of a first communication device and a second communication device according to the present disclosure, as shown in FIG. 4. FIG. 4 is a block diagram of a first communication device 410 and a second communication device 450 in communication with each other in an access network.

The first communication device 410 includes a controller/processor 475, a memory 476, a receiving processor 470, a transmitting processor 416, a multi-antenna receiving processor 472, a multi-antenna transmitting processor 471, a transmitter/receiver 418, and an antenna 420

The second communication device 450 includes a controller/processor 459, a memory 460, a data source 467, a transmitting processor 468, a receiving processor 456, a multi-antenna transmitting processor 457, a multi-antenna receiving processor 458, a transmitter/receiver 454, and an antenna 452

In the transmission from the first communication device 410 to the second communication device 450, at the first communication device 410, an upper layer data packet from the core network is provided to the controller/processor 475 controller/processor 475 to implement the functionality of the L2 layer. In the transmission from the first communication device 410 to the first communication device 450, the controller/processor 475 provides header compression, encryption, packet segmentation and reordering, multiplexing between the logic and the transport channel, and radio resource allocation for the second communication device 450 based on various priority metrics. The controller/processor 475 is also responsible for retransmission of a lost packet and signaling to the second communication device 450. The transmit processor 416 and the multi-antenna transmit processor 471 perform various signal processing functions for the L1 layer (that is, the physical layer). Transmit processor 416 performs encoding and interleaving to facilitate forward error correction (FEC) at the second communication device 450, and mapping of signal clusters based on various modulation schemes (e.g. binary phase shift keying (BPSK), quadrature phase shift keying (QPSK), M-phase shift keying (M-PSK), M quadrature amplitude modulation (M-QAM)). The multi-antenna transmitting processor 471 performs digital spatial precoding on the encoded and modulated symbols, including codebook-based precoding and non-codebook-based precoding and beamforming processing, to generate one or more spatial streams. Transmit processor 416 then maps each spatial stream to a subcarrier, multiplexes with a reference signal (e.g. pilot) in the time domain and/or frequency domain, and then uses an inverse fast Fourier transform (IFFT) to generate a physical channel that carries the time domain multicarrier symbol stream. Then, the multi-antenna transmitting processor 471 performs transmission analog precoding/beamforming on the time domain multi-carrier symbol stream. Each transmitter 418 converts the baseband multicarrier symbol stream provided by the multi-antenna transmitting processor 471 into a radio frequency stream, which is then provided to a different antenna 420

In the transmission from the first communication device 410 to the second communication device 450, at the second communication device 450, each receiver 454 receives a signal through its respective antenna 452. Each receiver 454 recovers information modulated onto a radio frequency carrier, and converts the radio frequency stream into a baseband multicarrier symbol stream, and provides various signal processing functions for implementing the L1 layer by the receiving processor 456 and the multi-antenna receiving processor 458. The multi-antenna receiving processor 458 performs reception analog precoding/beamforming on the baseband multicarrier symbol stream from the receiver 454. The receiving processor 456 converts the baseband multicarrier symbol stream after receiving the analog precoding/beamforming operation from the time domain to the frequency domain using a Fast Fourier Transform (FFT). In the frequency domain, the physical layer data signal and the reference signal are demultiplexed by the receiving processor 456, wherein the reference signal is used for channel estimation, and the data signal recovers any spatial stream destined for the second communication device 450 after multi-antenna detection in the multi-antenna receiving processor 458. The symbols on each spatial stream are demodulated and recovered in the receive processor 456 and a soft decision is generated. The receiving processor 456 then decodes and de-interleaves the soft decision to recover upper layer data and control signals transmitted on the physical channel by the first communication device 410. The upper layer data and control signals are then provided to the controller/processor 459 controller/processor 459 to implement the functions of the L2 layer. The controller/processor 459 can be associated with a memory 460 that stores program code and data. The memory 460 May be referred to as a computer-readable medium. In the transmission from the first communication device 410 to the second communication device 450, the controller/processor 459 provides demultiplexing between transport and logical channels, packet reassembly, deciphering, header decompression, control signal processing to recover upper layer data packets from the core network. The upper layer data packet is then provided to all protocol layers above the L2 layer. Various control signals may also be provided to L3 for L3 processing.

In the transmission from the second communication device 450 to the first communication device 410, at the second communication device 450, a data source 467 is used to provide an upper layer data packet to the controller/processor 459 data source 467 representing all protocol layers above the L2 layer. Similar to the transmission function at the first communication device 410 described in the transmission from the first communication device 410 to the second communication device 450, the controller/processor 459 performs header compression, encryption, packet segmentation and reordering, and multiplexing between the logic and the transport channel based on radio resource allocation, implementing L2 layer functions for the user plane and the control plane. The controller/processor 459 is also responsible for retransmission of a lost packet and signaling to the first communication device 410. The transmit processor 468 performs modulation mapping, channel encoding processing, and multi-antenna transmit processor 457 to perform digital multi-antenna spatial precoding, including codebook-based precoding and non-codebook-based precoding and beamforming processing, and then the transmit processor 468 modulates the generated spatial stream into a multi-carrier/single-carrier symbol stream, and after the analog precoding/beamforming operation is performed in the multi-antenna transmit processor 457, the transmitter 454 first converts a baseband symbol stream provided by the multi-antenna transmit processor 457 into a radio frequency symbol stream, and then provides the radio frequency symbol stream to the antenna 452

In the transmission from the second communication device 450 to the first communication device 410, the function at the first communication device 410 is similar to the receiving function at the second communication device 450 described in the transmission from the first communication device 410 to the second communication device 450. Each receiver 418 receives a radio frequency signal through its corresponding antenna 420, converts the received radio frequency signal into a baseband signal, and provides the baseband signal to the multi-antenna receiving processor 472 and the receiving processor 470 to receive the processor 470 and the multi-antenna receiving processor 472 to jointly implement the function of the L1 layer. The controller/processor 475 provides an L2 layer function. The controller/processor 475 can be associated with a memory 476 that stores program code and data. The memory 476 can be referred to as a computer-readable medium. In transmission from the second communication device 450 to the first communication device 410, the controller/processor 475 provides demultiplexing between transport and logical channels, packet reassembly, deciphering, header decompression, control signal processing to recover upper layer data packets from the UE 450. The upper layer data packet from the controller/processor 475 May be provided to the core network.

In one embodiment, the first node in the present disclosure includes the second communication device 450, and the second node in the present disclosure includes the first communication device 410

In one subembodiment of the above embodiment, the first node is a user equipment, and the second node is a user equipment.

In one subembodiment of the above embodiment, the first node is a user equipment, and the second node is a relay node.

In one subembodiment of the above embodiment, the first node is a relay node, and the second node is a user equipment.

In one subembodiment of the above embodiment, the first node is a relay node, and the second node is a relay node.

In one subembodiment of the above embodiment, the first node is a user equipment, and the second node is a roadside node.

In one subembodiment of the above embodiment, the first node is a roadside node, and the second node is a user equipment.

In one subembodiment of the above embodiment, the first node is a roadside node, and the second node is a roadside node.

In one subembodiment of the above embodiment, the second communication device 450 comprises: at least one controller/processor; and the at least one controller/processor is responsible for HARQ operation.

In one subembodiment of the above embodiment, the first communication device 410 comprises: at least one controller/processor; and the at least one controller/processor is responsible for HARQ operation.

In one subembodiment of the above embodiment, the first communication device 410 comprises: at least one controller/processor; the at least one controller/processor is responsible for performing error detection by using a positive acknowledgement (ACK) and/or a negative acknowledgement (NACK) protocol to support HARQ operations.

In one embodiment, the second communication device 450 comprises: at least one processor and at least one memory, wherein the at least one memory comprises computer program code, and the at least one memory and the computer program code are configured to be used with the at least one processor. The second communication device 450 includes at least one of: sending first control information and a first signal, where the first control information includes at least one of a source identifier field and a destination identifier field, the source identifier field is used to indicate the first node, the destination identifier field is used to indicate a target receiver of the first signal, and the first control information is carried on a first PSCCH or a first PSSCH related to the first signal.

In one embodiment, the second communication device 450 comprises: a memory storing a computer-readable instruction program, wherein the computer-readable instruction program generates an action when executed by at least one processor, and the action comprises: sending first control information and a first signal; the first control information includes at least one of a source identifier field and a destination identifier field, the source identifier field is used to indicate the first node, the destination identifier field is used to indicate a target receiver of the first signal, and the first control information is carried on a first PSCCH or a first PSSCH related to the first signal.

In one embodiment, the first communication device 410 comprises: at least one processor and at least one memory, wherein the at least one memory comprises computer program code, and the at least one memory and the computer program code are configured to be used with the at least one processor. The first communication device 410 at least receives first control information and a first signal, where the first control information includes at least one of a source identifier field and a destination identifier field, the source identifier field is used to indicate the first node, and the destination identifier field is used to indicate a target receiver of the first signal; and the first control information is carried on a first PSCCH or a first PSSCH related to the first signal.

In one embodiment, the first communication device 410 comprises: a memory storing a computer-readable instruction program, wherein the computer-readable instruction program generates an action when executed by at least one processor, and the action comprises: receiving first control information and a first signal; the first control information includes at least one of a source identifier field and a destination identifier field, the source identifier field is used to indicate the first node, the destination identifier field is used to indicate a target receiver of the first signal, and the first control information is carried on a first PSCCH or a first PSSCH related to the first signal.

In one embodiment, at least one of the antenna 452, the transmitter 454, the multi-antenna transmitting processor 457, the transmitting processor 468, the controller/processor 459, the memory 460, and the data source 467 is used for transmitting the first control information in the present disclosure.

In one embodiment, at least one of the antenna 452, the transmitter 454, the multi-antenna transmitting processor 457, the transmitting processor 468, the controller/processor 459, the memory 460, and the data source 467 is used for transmitting a first signal in the present disclosure.

In one embodiment, at least one of the antenna 452, the transmitter 454, the multi-antenna transmitting processor 457, the transmitting processor 468, the controller/processor 459, the memory 460, and the data source 467 is used for transmitting the second control information in the present disclosure.

In one embodiment, at least one of the antenna 452, the receiver 454, the multi-antenna receiving processor 458, the receiving processor 456, the controller/processor 459, and the memory 460} is used for receiving a second positioning reference signal on a target time-frequency resource block in the present disclosure.

In one embodiment, at least one of the antenna 420, the receiver 418, the multi-antenna receiving processor 472, the receiving processor 470, the controller/processor 475 or the memory 476 is used for receiving the first control information in the present disclosure.

In one embodiment, at least one of the antenna 420, the receiver 418, the multi-antenna receiving processor 472, the receiving processor 470, the controller/processor 475, and the memory 476 is used for receiving a first signal in the present disclosure.

In one embodiment, at least one of the antenna 420, the receiver 418, the multi-antenna receiving processor 472, the receiving processor 470, the controller/processor 475, and the memory 476 is used for receiving the second control information in the present disclosure.

In one embodiment, at least one of the antenna 420, the transmitter 418, the multi-antenna transmitting processor 471, the transmitting processor 416, the controller/processor 475, and the memory 476 is used for transmitting a second positioning reference signal on a target time-frequency resource block in the present disclosure.

### Example 5

Embodiment 5 illustrates a flowchart of wireless signal transmission according to one embodiment of the present disclosure, as shown in FIG. 5. In FIG. 5, the first node U1 communicates with the second node U2 through an air interface. In FIG. 5, the steps in dashed box F0 and dashed box F1 are optional, respectively.

For the first node U1, the second control information is sent in step S11; the first control information is sent in step S12; the first signal is sent in step S13; and the second positioning reference signal is received on the target time-frequency resource block in step S14.

For the second node U2, the second control information is received in step S21; the first control information is received in step S22; the first signal is received in step S23; and the second positioning reference signal is transmitted on the target time-frequency resource block in step S24.

In Embodiment 5, the first control information includes at least one of a source identifier field and a destination identifier field, the source identifier field is used to indicate the first node, and the destination identifier field is used to indicate a target receiver of the first signal; the first control information is carried on a first PSCCH or a first PSSCH related to the first signal; whether the first control information includes a first field is related to the first signal, the first field is used to indicate that the first signal is a first positioning reference signal, or the first field is used to indicate a format of the first control information; and whether the first control information indicates a time-frequency resource occupied by the first signal is related to the first signal.

In one embodiment, whether the first control information is carried on the first PSCCH is related to whether the first signal is a first positioning reference signal; the first signal is the first positioning reference signal, the first control information is carried on the first PSCCH, and the first control information indicates a time-frequency resource occupied by the first signal; alternatively, the first signal is first data, the first control information is carried on the first PSSCH, the first control information is not used to indicate a time-frequency resource occupied by the first signal, and the second control information is used to indicate a time-frequency resource occupied by the first signal.

In one embodiment, the first signal is the first positioning reference signal, whether the first control information is carried on the first PSCCH is related to a type of the first positioning reference signal, the type of candidate of the first positioning reference signal comprises a first positioning type and a second positioning type, and the first positioning type and the second positioning type are respectively associated with two different time-frequency maps of the first positioning reference signal; the type of the first positioning reference signal is the first positioning type, the first control information is carried on the first PSCCH, a time-frequency resource occupied by the first positioning reference signal and a time-frequency resource occupied by the first control information share a same resource pool, and the first control information indicates a time-frequency resource occupied by the first signal; alternatively, the type of the first positioning reference signal is the second positioning type, the first control information is carried on the first PSSCH, a time-frequency resource occupied by the first positioning reference signal and a time-frequency resource occupied by the first control information belong to different resource pools respectively, the first positioning reference signal is associated with the second positioning reference signal, the first control information is not used to indicate a time-frequency resource occupied by the first signal, and the second control information is used to indicate a time-frequency resource occupied by the first signal.

In one embodiment, whether the first control information is carried on the first PSCCH is related to whether the first signal is a first positioning reference signal; when the first signal is the first positioning reference signal, the first control information is carried on the first PSCCH, and the first control information indicates a time-frequency resource occupied by the first signal; when the first signal is first data, the first control information is carried on the first PSSCH, the first control information is not used to indicate a time-frequency resource occupied by the first signal, and the second control information is used to indicate a time-frequency resource occupied by the first signal.

In one embodiment, the first signal is the first positioning reference signal, whether the first control information is carried on the first PSCCH is related to a type of the first positioning reference signal, the type of the first positioning reference signal comprises a first positioning type and a second positioning type, and the first positioning type and the second positioning type are respectively associated with two different time-frequency maps of the first positioning reference signal; when the type of the first positioning reference signal is the first positioning type, the first control information is carried on the first PSCCH, a time-frequency resource occupied by the first positioning reference signal and a time-frequency resource occupied by the first control information share a same resource pool, and the first control information indicates a time-frequency resource occupied by the first signal; when the type of the first positioning reference signal is the second positioning type, the first control information is carried on the first PSSCH, a time-frequency resource occupied by the first positioning reference signal and a time-frequency resource occupied by the first control information belong to different resource pools respectively, the first positioning reference signal is associated with the second positioning reference signal, the first control information is not used to indicate a time-frequency resource occupied by the first signal, and the second control information is used to indicate a time-frequency resource occupied by the first signal.

In one embodiment, the first node U1 and the second node U2 communicate through a PC5 interface.

In one embodiment, the step in block F0 in FIG. 5 exists, and the step in block F1 in FIG. 5 does not exist.

In one embodiment, the steps in block F0 in FIG. 5 do not exist, and the steps in block F1 in FIG. 5 exist.

In one embodiment, none of the steps in block F0 in FIG. 5 and the steps in block F1 are present.

In one embodiment, when the first control information is carried on the first PSSCH, the step in block F0 in FIG. 5 exists, and the step in block F1 in FIG. 5 does not exist.

In one embodiment, when the first control information is carried on the first PSCCH, steps in block F0 in FIG. 5 do not exist, and steps in block F1 in FIG. 5 exist.

In one embodiment, when the first control information is carried on the first PSCCH, none of the steps in block F0 in FIG. 5 and the steps in block F1 exist.

In one embodiment, the first data is a baseband signal.

In one embodiment, the first data is a radio frequency signal.

In one embodiment, the first data is a wireless signal.

In one embodiment, the first data comprises a Packet.

In one embodiment, the first data comprises sidelink data (SL Data).

In one embodiment, the first data comprises available SL Data in one or more logical channels.

In one embodiment, the first data comprises one or more MAC data units (Protocol Data Units, Protocol Data Units).

In one embodiment, the first data comprises one or more Service Data Units (Service Data Units).

In one embodiment, the first data comprises one or more Transport Blocks (TBS).

In one embodiment, the first data is a Transport Block (TB).

In one embodiment, the first data comprises all or part of a Higher Layer signaling.

In one embodiment, the first data comprises an RRC-i.e. (Radio Resource Control-Information Element).

In one embodiment, the first data comprises a Multimedia Access Control-Control Element (MAC-CE).

In one embodiment, the first data is carried on a PSSCH.

In one embodiment, the first data is carried on the first PSSCH.

In one embodiment, the first signal is the first data, and both the first control signal and the first signal are carried on the first PSSCH.

In one embodiment, a propagation type of the first data is one of unicast, groupcast, or broadcast.

In one embodiment, the first data comprises a first bit block, and the first bit block comprises at least one bit.

In one embodiment, the first bit block is used to generate the first data.

In one embodiment, the first bit block is from a Sidelink Shared Channel (SL-SCH).

In one embodiment, the first bit block comprises 1 CW (Codeword).

In one embodiment, the first bit block comprises 1 CB (Code Block).

In one embodiment, the first bit block comprises a Code Block Group (CBG).

In one embodiment, the first bit block comprises one Transport Block (TB).

In one embodiment, all or part of the bits in the first bit block are sequentially subjected to a transport block level CRC (Cyclic Redundancy Check) attachment, a coding block segmentation (Coding Block Segmentation), a coding block level CRC attachment, a channel coding (Channel Coding), a rate matching (Modulation), a Layer Mapping (Layer Mapping), an antenna port mapping (Antenna Port Mapping), a Mapping to Physical Resource Block (Physical Resource Block), a Baseband Signal Generation (Baseband Signal Generation), a Modulation and Upconversion (Modulation and Upconversion), to obtain the first data.

In one embodiment, the first data is an output after the first bit block sequentially passes through a modulation mapper, a layer mapper, a precoding, a resource element mapper, and a multi-carrier symbol generation.

In one embodiment, the channel coding is based on a Polar code.

In one embodiment, the channel coding is based on a Low-Density Parity-Check (LDPC) code.

In one embodiment, the first positioning reference signal is used for sidelink positioning (SL Positioning).

In one embodiment, the first positioning reference signal is used to obtain an absolute position (Absolute Position).

In one embodiment, the first positioning reference signal is used to obtain a relative position.

In one embodiment, the first positioning reference signal is used to obtain a distance.

In one embodiment, the first positioning reference signal is used to obtain a range.

In one embodiment, the first positioning reference signal is a Positioning Reference Signal (PRS).

In one embodiment, the first positioning reference signal is a Sidelink Positioning Reference Signal (SL PRS).

In one embodiment, the first positioning reference signal comprises an SL PRS.

In one embodiment, the first positioning reference signal comprises an SL SSB (a Sidelink Synchronization Signal/Physical Sidelink Broadcast Channel Block, an S-SS PSBCH Block, a sidelink synchronization signal/a physical sidelink broadcast channel block).

In one embodiment, the first positioning reference signal comprises an SL PTRS (Sidelink Phase Tracking Reference Signal, Sidelink Phase Tracking Reference Signal).

In one embodiment, the first positioning reference signal comprises an SL CSI-RS (Sidelink Channel State Information Reference Signal, Sidelink Channel State Information Reference Signal).

In one embodiment, the first positioning reference signal comprises a PSCCH DMRS (PSCCH Demodulation Reference Signal, PSCCH demodulation reference signal).

In one embodiment, the first positioning reference signal comprises a PSSCH DMRS (PSSCH Demodulation Reference Signal, PSSCH demodulation reference signal).

In one embodiment, the first positioning reference signal comprises at least one of SL PRS, SL PTRS, SL CSI-RS, PSCCH DMRS, PSSCH DMRS, and SL-SSB.

In one embodiment, the first positioning reference signal comprises a first sequence.

In one embodiment, a first sequence is used to generate the first positioning reference signal.

In one embodiment, the first sequence is a Pseudo-Random Sequence (Pseudo-Random Sequence).

In one embodiment, the first sequence is a Low-PAPR Sequence (Low-PAPR Sequence, Low-Peak to Average Power Ratio Sequence).

In one embodiment, the first sequence is a Gold sequence.

In one embodiment, the first sequence is an M sequence.

In one embodiment, the first sequence is a Zadeoff-Chu (ZC) sequence.

In one embodiment, the first sequence is obtained by a Sequence Generation (Sequence Generation), a Physical Resource Mapping (Mapping to Physical Resources), and a Mapping to Slots.

In one embodiment, a time-domain resource occupied by the first positioning reference signal belongs to a time slot.

In one embodiment, a time-domain resource occupied by the first positioning reference signal comprises at least one symbol.

In one embodiment, the first positioning reference signal occupies at least one symbol in a time domain.

In one embodiment, the first positioning reference signal occupies at least one symbol in a time slot in a time domain.

In one embodiment, a frequency-domain resource occupied by the first positioning reference signal belongs to a resource pool.

In one embodiment, a time-domain resource occupied by the first positioning reference signal comprises at least one physical resource block.

In one embodiment, a time-domain resource occupied by the first positioning reference signal comprises at least one sub-channel.

In one embodiment, the first positioning reference signal occupies at least one physical resource block in a frequency domain.

In one embodiment, the first positioning reference signal occupies at least one physical resource block in a resource pool in a frequency domain.

In one embodiment, the first positioning reference signal occupies at least one sub-channel in a frequency domain.

In one embodiment, the first positioning reference signal occupies at least one sub-channel in a resource pool in a frequency domain.

In one embodiment, a type of the first positioning reference signal comprises a first positioning type and a second positioning type.

In one embodiment, a type of the first positioning reference signal is one of a first positioning type or a second positioning type.

In one embodiment, the type of the first positioning reference signal comprises a plurality of positioning types, and the first positioning type and the second positioning type are respectively two of the plurality of positioning types.

In one embodiment, a type of the first positioning reference signal is one of a plurality of positioning types, and the plurality of positioning types comprise a first positioning type and a second positioning type.

In one embodiment, the type of the first positioning reference signal is the first positioning type.

In one embodiment, the type of the first positioning reference signal is the second positioning type.

In one embodiment, the second positioning reference signal is used for sidelink positioning.

In one embodiment, the second positioning reference signal is used to obtain an absolute position.

In one embodiment, the second positioning reference signal is used to obtain a relative position.

In one embodiment, the second positioning reference signal is used to obtain a distance.

In one embodiment, the second positioning reference signal is used to obtain a range.

In one embodiment, the second positioning reference signal is a PRS.

In one embodiment, the second positioning reference signal is an SL PRS.

In one embodiment, the second positioning reference signal comprises an SL PRS.

In one embodiment, the second positioning reference signal comprises an SL SSB.

In one embodiment, the second positioning reference signal comprises an SL PTRS.

In one embodiment, the second positioning reference signal comprises an SL CSI-RS.

In one embodiment, the second positioning reference signal comprises a PSCCH DMRS.

In one embodiment, the second positioning reference signal comprises a PSSCH DMRS.

In one embodiment, the second positioning reference signal comprises at least one of SL PRS, SL PTRS, SL CSI-RS, PSCCH DMRS, PSSCH DMRS, and SL-SSB.

In one embodiment, the second positioning reference signal comprises a second sequence.

In one embodiment, the second sequence is used to generate the second positioning reference signal.

In one embodiment, the second sequence is a pseudo-random sequence.

In one embodiment, the second sequence is a low-peak-to-average sequence.

In one embodiment, the second sequence is a Gold sequence.

In one embodiment, the second sequence is an M sequence.

In one embodiment, the second sequence is a ZC sequence.

In one embodiment, the second sequence is subjected to sequence generation, physical resource mapping, and slot mapping to obtain the second positioning reference signal.

In one embodiment, a time-domain resource occupied by the second positioning reference signal belongs to a time slot.

In one embodiment, a time-domain resource occupied by the second positioning reference signal comprises at least one symbol.

In one embodiment, the second positioning reference signal occupies at least one symbol in a time domain.

In one embodiment, the second positioning reference signal occupies at least one symbol in a time slot in a time domain.

In one embodiment, a frequency-domain resource occupied by the second positioning reference signal belongs to a resource pool.

In one embodiment, a time-domain resource occupied by the second positioning reference signal comprises at least one physical resource block.

In one embodiment, a time-domain resource occupied by the second positioning reference signal comprises at least one sub-channel.

In one embodiment, the second positioning reference signal occupies at least one physical resource block in a frequency domain.

In one embodiment, the second positioning reference signal occupies at least one physical resource block in a resource pool in a frequency domain.

In one embodiment, the second positioning reference signal occupies at least one sub-channel in a frequency domain.

In one embodiment, the second positioning reference signal occupies at least one sub-channel in a resource pool in a frequency domain.

In one embodiment, the first positioning reference signal is associated with the second positioning reference signal.

In one embodiment, the transmission of the first positioning reference signal is used to trigger receiving the second positioning reference signal.

In one embodiment, a time-domain resource occupied by the first positioning reference signal is used to determine a time-domain resource occupied by the second positioning reference signal.

In one embodiment, a time-frequency resource occupied by the first positioning reference signal is used to determine a time-frequency resource occupied by the second positioning reference signal.

In one embodiment, a time-domain resource occupied by the first positioning reference signal is used to determine the target time-frequency resource block, and the target time-frequency resource block is used to carry the second positioning reference signal.

In one embodiment, a time-frequency resource occupied by the first positioning reference signal is used to determine the target time-frequency resource block, and the target time-frequency resource block is used to carry the second positioning reference signal.

In one embodiment, the first control information is associated with the first positioning reference signal, and the first control information is used to indicate the second positioning reference signal.

In one embodiment, the first control information is used to indicate the first positioning reference signal, and the first control information is used to indicate a resource pool to which a time-frequency resource occupied by the second positioning reference signal belongs.

In one embodiment, the first control information is used to indicate the first positioning reference signal, the first control information is used to indicate a resource pool to which the target time-frequency resource block belongs, and the target time-frequency resource block is used to carry the second positioning reference signal.

In one embodiment, the first control information is used to indicate a time-frequency resource occupied by the first positioning reference signal, and the first control information is used to indicate a resource pool to which a time-frequency resource occupied by the second positioning reference signal belongs.

In one embodiment, the first control information is used to indicate a resource pool to which a time-frequency resource occupied by the first positioning reference signal belongs, the first control information is used to indicate a resource pool to which the target time-frequency resource block belongs, and the target time-frequency resource block is used to carry the second positioning reference signal.

In one embodiment, the first control information is used to indicate the first positioning reference signal, and the first control information is used to indicate the second positioning reference signal.

In one embodiment, the first control information is used to indicate the first positioning reference signal, and the first control information is used to indicate a time-frequency resource occupied by the second positioning reference signal.

In one embodiment, the first control information is used to indicate the first positioning reference signal, the first control information is used to indicate the target time-frequency resource block, and the target time-frequency resource block is used to carry the second positioning reference signal.

In one embodiment, the first control information is used to indicate a time-frequency resource occupied by the first positioning reference signal, and the first control information is used to indicate a time-frequency resource occupied by the second positioning reference signal.

In one embodiment, the first control information is used to indicate a time-frequency resource occupied by the first positioning reference signal, the first control information is used to indicate the target time-frequency resource block, and the target time-frequency resource block is used to carry the second positioning reference signal.

In one embodiment, whether the first positioning reference signal is associated with the second positioning reference signal is related to the type of the first positioning reference signal.

In one embodiment, the type of the first positioning reference signal is used to determine whether the first positioning reference signal is associated with the second positioning reference signal.

In one embodiment, the type of the first positioning reference signal is the second positioning type, and the first positioning reference signal is associated with the second positioning reference signal.

In one embodiment, the type of the first positioning reference signal is the first positioning type, and the first positioning reference signal is not associated with the second positioning reference signal.

In one embodiment, the type of the first positioning reference signal is the first positioning type, and the first positioning reference signal is associated with the second positioning reference signal.

In one embodiment, when the type of the first positioning reference signal is the second positioning type, the first positioning reference signal is associated with the second positioning reference signal.

In one embodiment, when the type of the first positioning reference signal is the first positioning type, the first positioning reference signal is not associated with the second positioning reference signal.

In one embodiment, when the type of the first positioning reference signal is the first positioning type, the first positioning reference signal is associated with the second positioning reference signal.

In one embodiment, the type of the first positioning reference signal is the second positioning type, and the first positioning reference signal is associated with the second positioning reference signal; or the type of the first positioning reference signal is the first positioning type, and the first positioning reference signal is not associated with the second positioning reference signal.

In one embodiment, the type of the first positioning reference signal is the first positioning type, and the first positioning reference signal is associated with the second positioning reference signal; or the type of the first positioning reference signal is the second positioning type, and the first positioning reference signal is not associated with the second positioning reference signal.

In one embodiment, when the type of the first positioning reference signal is the second positioning type, the first positioning reference signal is associated with the second positioning reference signal; and when the type of the first positioning reference signal is the first positioning type, the first positioning reference signal is not associated with the second positioning reference signal.

In one embodiment, when the type of the first positioning reference signal is the first positioning type, the first positioning reference signal is associated with the second positioning reference signal; and when the type of the first positioning reference signal is the second positioning type, the first positioning reference signal is not associated with the second positioning reference signal.

In one embodiment, the target time-frequency resource block is used to carry the second positioning reference signal.

In one embodiment, the target time-frequency resource block is used to carry an SL PRS.

In one embodiment, the target time-frequency resource block comprises a PSCCH.

In one embodiment, the target time-frequency resource block does not comprise a PSCCH.

In one embodiment, the target time-frequency resource block comprises a PSSCH.

In one embodiment, the target time-frequency resource block does not comprise a PSSCH.

In one embodiment, the target time-frequency resource block is used to carry an SL PRS, and the target time-frequency resource block comprises a PSCCH.

In one embodiment, the target time-frequency resource block is only used to carry an SL PRS, and the target time-frequency resource block does not include a PSCCH and a PSSCH.

In one embodiment, the second node U2 automatically determines the target time-frequency resource block from a plurality of time-frequency resource blocks comprised in a resource pool.

In one embodiment, the second node U2 randomly selects the target time-frequency resource block from a plurality of time-frequency resource blocks comprised in a resource pool.

In one embodiment, a downlink signaling indicates the target time-frequency resource block from a plurality of time-frequency resource blocks comprised in one resource pool.

In one embodiment, a downlink signaling indicates a position of the target time-frequency resource block in a plurality of time-frequency resource blocks comprised in a resource pool.

### Example 6

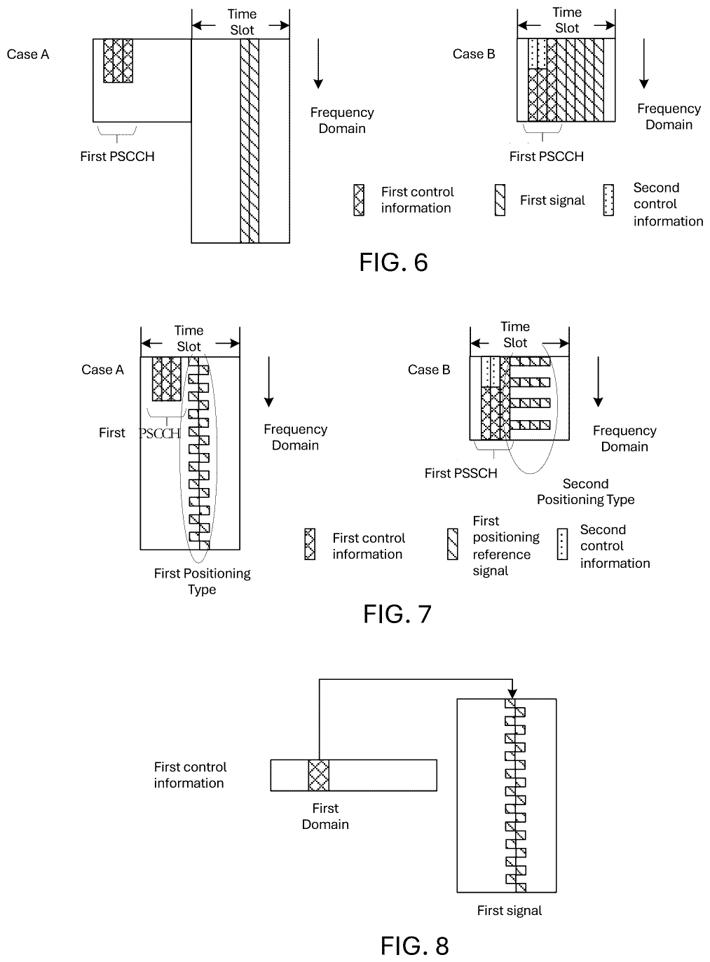

Embodiment 6 illustrates a schematic diagram of a relationship between first control information and a first signal according to one embodiment of the present disclosure, as shown in FIG. 6. In FIG. 6, the rectangle filled with the diagonal squares represents the first control information in the present disclosure, the rectangle filled with the twill represents the first signal in the present disclosure, and the rectangle filled with the wave point represents the second control information in the present disclosure.

In Embodiment 6, a channel carried by the first control information is related to the first signal, and the channel carried in the first control information is one of the first PSCCH or the first PSSCH; in case A of Embodiment 6, the first signal is the first positioning reference signal, and the first control information is carried on the first PSCCH; in case B of Embodiment 6, the first signal is the first data, and the first control information is carried on the first PSSCH.

In one embodiment, the first signal is used to determine the channel carried by the first control information.

In one embodiment, a candidate of the channel carried by the first control information comprises the first PSCCH and the first PSSCH.

In one embodiment, the channel carried by the first control information is one of the first PSCCH or the first PSSCH.

In one embodiment, the channel carried by the first control information is the first PSCCH.

In one embodiment, the channel carried by the first control information is the first PSSCH.

In one embodiment, the first control information is carried on the first PSCCH.

In one embodiment, the first control information is carried on the first PSSCH.

In one embodiment, the channel carried by the first control information is related to whether the first signal is the first positioning reference signal.

In one embodiment, whether the first control information is carried on the first PSCCH is related to the first signal.

In one embodiment, whether the first control information is carried on the first PSCCH is related to whether the first signal is the first positioning reference signal.

In one embodiment, the first signal is the first positioning reference signal, and the first control information is carried on the first PSCCH.

In one embodiment, the first signal is not the first positioning reference signal, and the first control information is not carried on the first PSCCH.

In one embodiment, the first signal is not the first positioning reference signal, and the first control information is carried on the first PSSCH.

In one embodiment, the first signal is the first data, and the first control information is not carried on the first PSCCH.

In one embodiment, the first signal is the first data, and the first control information is carried on the first PSSCH.

In one embodiment, when the first signal is the first positioning reference signal, the first control information is carried on the first PSCCH.

In one embodiment, when the first signal is the first data, the first control information is carried on the first PSSCH.

In one embodiment, the first signal is the first positioning reference signal, and the first control information is carried on the first PSCCH; or the first signal is not the first positioning reference signal, and the first control information is carried on the first PSSCH.

In one embodiment, the first signal is the first positioning reference signal, and the first control information is carried on the first PSCCH; or the first signal is the first data, and the first control information is carried on the first PSSCH.

In one embodiment, when the first signal is the first positioning reference signal, the first control information is carried on the first PSCCH; and when the first signal is the first data, the first control information is carried on the first PSSCH.

In one embodiment, whether the first control information indicates that a time-frequency resource occupied by the first signal is related to the first signal.

In one embodiment, a time-frequency resource occupied by the first signal comprises a time-domain resource occupied by the first signal.

In one embodiment, a time-frequency resource occupied by the first signal comprises a frequency-domain resource occupied by the first signal.

In one embodiment, whether the first control information indicates whether a time-frequency resource occupied by the first signal is related to whether the first signal is the first positioning reference signal.

In one embodiment, the first signal is the first positioning reference signal, and the first control information indicates a time-frequency resource occupied by the first signal.

In one embodiment, the first signal is the first positioning reference signal, and the first control information is a first-stage SCI.

In one embodiment, the first signal is the first positioning reference signal, and the first control information is single-stage SCI.

In one embodiment, the first signal is the first positioning reference signal, and the first signal is only associated with the first control information.

In one embodiment, the first signal is the first positioning reference signal, and the first signal is only associated with a single-stage SCI.

In one embodiment, the first signal is the first positioning reference signal, and the first signal is associated with only one SCI.

In one embodiment, the first signal is the first data, and the first control information is not used to indicate a time-frequency resource occupied by the first signal.

In one embodiment, the first signal is the first data, the first control information is not used to indicate a time-frequency resource occupied by the first signal, and the second control information is used to indicate a time-frequency resource occupied by the first signal.

In one embodiment, the first signal is the first data, the first control information is a second-stage SCI, and the second control information is a first-stage SCI.

In one embodiment, the first signal is the first data, and the first signal is associated with the first control information and the second control information.

In one embodiment, the first signal is the first data, and the first signal is associated with two-stage SCI.

In one embodiment, the first signal is the first data, and the first signal is associated with two SCIs.

In one embodiment, when the first signal is the first positioning reference signal, the first control information indicates a time-frequency resource occupied by the first signal.

In one embodiment, the first signal is the first positioning reference signal, and the first control information indicates a time-frequency resource occupied by the first signal; or the first signal is the first data, the first control information is not used to indicate a time-frequency resource occupied by the first signal, and the second control information is used to indicate a time-frequency resource occupied by the first signal.

In one embodiment, when the first signal is the first positioning reference signal, the first control information indicates a time-frequency resource occupied by the first signal; and when the first signal is the first data, the first control information is not used to indicate a time-frequency resource occupied by the first signal, and the second control information is used to indicate a time-frequency resource occupied by the first signal.

In one embodiment, the first signal is the first positioning reference signal, and the first signal is only associated with the first control information; or the first signal is the first data, and the first signal is associated with the first control information and the second control information.

In one embodiment, when the first signal is the first positioning reference signal, the first signal is only associated with the first control information; and when the first signal is the first data, the first signal is associated with the first control information and the second control information.

In one embodiment, time-frequency resources occupied by the first PSCCH and time-frequency resources occupied by the first signal respectively belong to two different time slots.

In one embodiment, a time-frequency resource occupied by the first PSSCH and a time-frequency resource occupied by the first signal belong to a same time slot.

In one embodiment, time-frequency resources occupied by the first PSCCH and time-frequency resources occupied by the first signal respectively belong to two different resource pools.

In one embodiment, a time-frequency resource occupied by the first PSSCH and a time-frequency resource occupied by the first signal belong to a same resource pool.

In one embodiment, a time-frequency resource occupied by the first PSCCH and a time-frequency resource occupied by the first signal belong to a same time slot.

In one embodiment, a time-frequency resource occupied by the first PSCCH and a time-frequency resource occupied by the first signal belong to a same resource pool.

In one embodiment, whether a time-frequency resource occupied by the first control information and a time-frequency resource occupied by the first signal belong to a same resource pool is related to the first signal.

In one embodiment, whether a time-frequency resource occupied by the first control information and a time-frequency resource occupied by the first signal belong to a same time slot is related to the first signal.

In one embodiment, whether a time-frequency resource occupied by the first control information and a time-frequency resource occupied by the first signal belong to a same resource pool is related to whether the first signal is the first positioning reference signal.

In one embodiment, whether a time-frequency resource occupied by the first control information and a time-frequency resource occupied by the first signal belong to a same time slot is related to whether the first signal is the first positioning reference signal.

In one embodiment, the first signal is the first positioning reference signal, and a time-frequency resource occupied by the first control information and a time-frequency resource occupied by the first signal respectively belong to two different resource pools.

In one embodiment, the first signal is the first positioning reference signal, and a time-frequency resource occupied by the first control information and a time-frequency resource occupied by the first signal respectively belong to two different time slots.

In one embodiment, the first signal is the first data, and a time-frequency resource occupied by the first control information and a time-frequency resource occupied by the first signal belong to a same resource pool.

In one embodiment, the first signal is the first data, and a time-frequency resource occupied by the first control information and a time-frequency resource occupied by the first signal belong to a same time slot.

In one embodiment, the first signal is the first positioning reference signal, and a time-frequency resource occupied by the first control information and a time-frequency resource occupied by the first signal respectively belong to two different resource pools; or the first signal is the first data, and a time-frequency resource occupied by the first control information and a time-frequency resource occupied by the first signal belong to a same resource pool.

In one embodiment, the first signal is the first positioning reference signal, and a time-frequency resource occupied by the first control information and a time-frequency resource occupied by the first signal respectively belong to two different time slots; or the first signal is the first data, and a time-frequency resource occupied by the first control information and a time-frequency resource occupied by the first signal belong to a same time slot.

In one embodiment, when the first signal is the first positioning reference signal, a time-frequency resource occupied by the first control information and a time-frequency resource occupied by the first signal respectively belong to two different resource pools.

In one embodiment, when the first signal is the first positioning reference signal, a time-frequency resource occupied by the first control information and a time-frequency resource occupied by the first signal respectively belong to two different time slots.

In one embodiment, when the first signal is the first data, a time-frequency resource occupied by the first control information and a time-frequency resource occupied by the first signal belong to a same resource pool.

In one embodiment, when the first signal is the first data, a time-frequency resource occupied by the first control information and a time-frequency resource occupied by the first signal belong to a same time slot.

In one embodiment, when the first signal is the first positioning reference signal, a time-frequency resource occupied by the first control information and a time-frequency resource occupied by the first signal respectively belong to two different resource pools; and when the first signal is the first data, a time-frequency resource occupied by the first control information and a time-frequency resource occupied by the first signal belong to a same resource pool.

In one embodiment, when the first signal is the first positioning reference signal, a time-frequency resource occupied by the first control information and a time-frequency resource occupied by the first signal respectively belong to two different time slots; and when the first signal is the first data, a time-frequency resource occupied by the first control information and a time-frequency resource occupied by the first signal belong to a same time slot.

In one embodiment, the first signal is the first positioning reference signal, the first control information is carried on the first PSCCH, and a time-frequency resource occupied by the first PSCCH and a time-frequency resource occupied by the first signal respectively belong to two different resource pools; alternatively, the first signal is the first data, the first control information is carried on the first PSSCH, and a time-frequency resource occupied by the first PSSCH and a time-frequency resource occupied by the first signal belong to a same resource pool.

In one embodiment, the first signal is the first positioning reference signal, the first control information is carried on the first PSCCH, and a time-frequency resource occupied by the first PSCCH and a time-frequency resource occupied by the first signal respectively belong to two different time slots; alternatively, the first signal is the first data, the first control information is carried on the first PSSCH, and a time-frequency resource occupied by the first PSSCH and a time-frequency resource occupied by the first signal belong to a same slot.

In one embodiment, the first signal is the first positioning reference signal, the first control information is carried on the first PSCCH, and a time-frequency resource occupied by the first PSCCH and a time-frequency resource occupied by the first signal respectively belong to two different resource pools; or the first signal is the first data, and both the first control information and the first signal are carried on the first PSSCH.

In one embodiment, the first signal is the first positioning reference signal, the first control information is carried on the first PSCCH, and a time-frequency resource occupied by the first PSCCH and a time-frequency resource occupied by the first signal respectively belong to two different time slots; or the first signal is the first data, and both the first control information and the first signal are carried on the first PSSCH.

### Example 7

Embodiment 7 illustrates a schematic diagram of a relationship between first control information and a first signal according to one embodiment of the present disclosure, as shown in FIG. 7. In FIG. 7, the rectangle filled with the diagonal squares represents the first control information in the present disclosure, the rectangle filled with the twill represents the first positioning reference signal in the present disclosure, and the rectangle filled with the wave point represents the second control information in the present disclosure; in case A, the type of the first positioning reference signal is a time-frequency spectrum associated with the first positioning type in the present disclosure; in case B, the type of the first positioning reference signal is a time-frequency spectrum associated with the second positioning type in the present disclosure.

In Embodiment 7, the first signal is the first positioning reference signal; a channel carried by the first control information is related to a type of the first positioning reference signal, and the channel borne by the first control information is one of the first PSCCH or the first PSSCH; and the type of candidate of the first positioning reference signal includes the first positioning type and the second positioning type.

In one embodiment, the type of the first positioning reference signal is the first positioning type, and the first control information is carried on the first PSCCH.

In one embodiment, the type of the first positioning reference signal is the second positioning type, and the first control information is carried on the first PSSCH.

In one embodiment, the type of the first positioning reference signal is the first positioning type, and the first control information is carried on the first PSCCH; or the type of the first positioning reference signal is the second positioning type, and the first control information is carried on the first PSSCH.

In one embodiment, when the type of the first positioning reference signal is the first positioning type, the first control information is carried on the first PSCCH.

In one embodiment, when the type of the first positioning reference signal is the second positioning type, the first control information is carried on the first PSSCH.

In one embodiment, when the type of the first positioning reference signal is the first positioning type, the first control information is carried on the first PSCCH; and when the type of the first positioning reference signal is the second positioning type, the first control information is carried on the first PSSCH.

In one embodiment, the first signal is the first positioning reference signal, and whether a time-frequency resource occupied by the first control information and a time-frequency resource occupied by the first signal belong to a same resource pool is related to the type of the first positioning reference signal.

In one embodiment, the first signal is the first positioning reference signal, and whether a time-frequency resource occupied by the first control information and a time-frequency resource occupied by the first signal belong to a same time slot is related to the type of the first positioning reference signal.

In one embodiment, the first signal is the first positioning reference signal, and whether a time-frequency resource occupied by the first control information and a time-frequency resource occupied by the first signal belong to a same resource pool is related to whether the type of the first positioning reference signal is the first positioning type.

In one embodiment, the first signal is the first positioning reference signal, and whether a time-frequency resource occupied by the first control information and a time-frequency resource occupied by the first signal belong to a same time slot is related to whether the type of the first positioning reference signal is the first positioning type.

In one embodiment, the first signal is the first positioning reference signal; the type of the first positioning reference signal is the first positioning type, and a time-frequency resource occupied by the first control information and a time-frequency resource occupied by the first signal respectively belong to two different resource pools.

In one embodiment, the first signal is the first positioning reference signal; the type of the first positioning reference signal is the first positioning type, and a time-frequency resource occupied by the first control information and a time-frequency resource occupied by the first signal respectively belong to two different time slots.

In one embodiment, the first signal is the first positioning reference signal; the type of the first positioning reference signal is the second positioning type, and a time-frequency resource occupied by the first control information and a time-frequency resource occupied by the first signal belong to a same resource pool.

In one embodiment, the first signal is the first positioning reference signal; the type of the first positioning reference signal is the second positioning type, and a time-frequency resource occupied by the first control information and a time-frequency resource occupied by the first signal belong to a same time slot.

In one embodiment, the first signal is the first positioning reference signal; the type of the first positioning reference signal is the first positioning type, and a time-frequency resource occupied by the first control information and a time-frequency resource occupied by the first signal respectively belong to two different resource pools; or the type of the first positioning reference signal is the second positioning type, and a time-frequency resource occupied by the first control information and a time-frequency resource occupied by the first signal belong to a same resource pool.

In one embodiment, the first signal is the first positioning reference signal; the type of the first positioning reference signal is the first positioning type, and a time-frequency resource occupied by the first control information and a time-frequency resource occupied by the first signal respectively belong to two different time slots; or the type of the first positioning reference signal is the second positioning type, and a time-frequency resource occupied by the first control information and a time-frequency resource occupied by the first signal belong to a same time slot.

In one embodiment, the first signal is the first positioning reference signal; and when the type of the first positioning reference signal is the first positioning type, a time-frequency resource occupied by the first control information and a time-frequency resource occupied by the first signal respectively belong to two different resource pools.

In one embodiment, the first signal is the first positioning reference signal; and when the type of the first positioning reference signal is the first positioning type, a time-frequency resource occupied by the first control information and a time-frequency resource occupied by the first signal respectively belong to two different time slots.

In one embodiment, the first signal is the first positioning reference signal; and when the type of the first positioning reference signal is the second positioning type, a time-frequency resource occupied by the first control information and a time-frequency resource occupied by the first signal belong to a same resource pool.

In one embodiment, the first signal is the first positioning reference signal; and when the type of the first positioning reference signal is the second positioning type, a time-frequency resource occupied by the first control information and a time-frequency resource occupied by the first signal belong to a same time slot.

In one embodiment, the first signal is the first positioning reference signal; when the type of the first positioning reference signal is the first positioning type, a time-frequency resource occupied by the first control information and a time-frequency resource occupied by the first signal respectively belong to two different resource pools; and when the type of the first positioning reference signal is the second positioning type, a time-frequency resource occupied by the first control information and a time-frequency resource occupied by the first signal belong to a same resource pool.

In one embodiment, the first signal is the first positioning reference signal; when the type of the first positioning reference signal is the first positioning type, a time-frequency resource occupied by the first control information and a time-frequency resource occupied by the first signal respectively belong to two different time slots; and when the type of the first positioning reference signal is the second positioning type, a time-frequency resource occupied by the first control information and a time-frequency resource occupied by the first signal belong to a same time slot.

In one embodiment, the first signal is the first positioning reference signal; the type of the first positioning reference signal is the first positioning type, the first control information is carried on the first PSCCH, and a time-frequency resource occupied by the first PSCCH and a time-frequency resource occupied by the first signal respectively belong to two different resource pools; alternatively, the type of the first positioning reference signal is the second positioning type, the first control information is carried on the first PSSCH, and a time-frequency resource occupied by the first PSSCH and a time-frequency resource occupied by the first signal belong to a same resource pool.

In one embodiment, the first signal is the first positioning reference signal; the type of the first positioning reference signal is the first positioning type, the first control information is carried on the first PSCCH, and a time-frequency resource occupied by the first PSCCH and a time-frequency resource occupied by the first signal respectively belong to two different time slots; alternatively, the type of the first positioning reference signal is the second positioning type, the first control information is carried on the first PSSCH, and a time-frequency resource occupied by the first PSSCH and a time-frequency resource occupied by the first signal belong to a same slot.

In one embodiment, the first signal is the first positioning reference signal; the type of the first positioning reference signal is the first positioning type, the first control information is carried on the first PSCCH, and a time-frequency resource occupied by the first PSCCH and a time-frequency resource occupied by the first signal respectively belong to two different resource pools; alternatively, the type of the first positioning reference signal is the second positioning type, and both the first control information and the first signal are carried on the first PSSCH.

In one embodiment, the first signal is the first positioning reference signal; the type of the first positioning reference signal is the first positioning type, the first control information is carried on the first PSCCH, and a time-frequency resource occupied by the first PSCCH and a time-frequency resource occupied by the first signal respectively belong to two different time slots; alternatively, the type of the first positioning reference signal is the second positioning type, and both the first control information and the first signal are carried on the first PSSCH.

In one embodiment, the first positioning type and the second positioning type are respectively associated with two different time-frequency maps (Patterns) of the first positioning reference signal.

In one embodiment, the first positioning type and the second positioning type are respectively associated with two different port numbers (Port Number) of the first positioning reference signal.

In one embodiment, the type of the first positioning reference signal is the first positioning type, and a map of the first positioning reference signal is an interleaving map.

In one embodiment, the type of the first positioning reference signal is the first positioning type, and a map of the first positioning reference signal is a Full Staggered Pattern.

In one embodiment, the type of the first positioning reference signal is the first positioning type, and a map of the first positioning reference signal is a semi-interleaved pattern.

In one embodiment, the type of the first positioning reference signal is the second positioning type, and a map of the first positioning reference signal is a non-staggered pattern.

In one embodiment, the type of the first positioning reference signal is the second positioning type, and a map of the first positioning reference signal is a semi-interleaved map.

In one embodiment, the type of the first positioning reference signal is the first positioning type, and a map of the first positioning reference signal is a staggered map; or the type of the first positioning reference signal is the second positioning type, and a map of the first positioning reference signal is a non-staggered map.

In one embodiment, the type of the first positioning reference signal is the first positioning type, and a map of the first positioning reference signal is a full-interleaving map; or the type of the first positioning reference signal is the second positioning type, and a map of the first positioning reference signal is a semi-interleaved map.

In one embodiment, the type of the first positioning reference signal is the first positioning type, and a map of the first positioning reference signal is a full-interleaving map; or the type of the first positioning reference signal is the second positioning type, and a map of the first positioning reference signal is a non-staggered map.

In one embodiment, the type of the first positioning reference signal is the first positioning type, and a map of the first positioning reference signal is a non-staggered map; or the type of the first positioning reference signal is the second positioning type, and a map of the first positioning reference signal is a full-interleaving map.

In one embodiment, the first positioning type and the second positioning type are respectively associated with two different multicarrier symbol numbers occupied by the first positioning reference signal in a time domain.

In one embodiment, the type of the first positioning reference signal is the first positioning type, the first positioning reference signal occupies L1 multicarrier symbols in a time domain, and L1 is a positive integer not greater than 14.

In one embodiment, the type of the first positioning reference signal is the second positioning type, the first positioning reference signal occupies L2 multicarrier symbols in a time domain, L2 is a positive integer not greater than 14, and L2 is unequal to L1.

In one embodiment, the L1 is greater than the L2.

In one embodiment, the L1 is less than the L2.

In one embodiment, the type of the first positioning reference signal is the first positioning type, and the first positioning reference signal occupies 12 multicarrier symbols in a time domain.

In one embodiment, the type of the first positioning reference signal is the second positioning type, and the first positioning reference signal occupies two multicarrier symbols in a time domain.

In one embodiment, the type of the first positioning reference signal is the first positioning type, and the first positioning reference signal occupies L1 multicarrier symbols in a time domain; or the type of the first positioning reference signal is the second positioning type, the first positioning reference signal occupies L2 multicarrier symbols in a time domain, L2 is a positive integer not greater than 14, and L2 is unequal to L1.

### Example 8

Embodiment 8 illustrates a schematic diagram of a relationship between first control information, a first domain, and a first signal according to one embodiment of the present disclosure, as shown in FIG. 8. The rectangle filled with the diagonal squares represents the first field in the present disclosure, and the rectangle filled by the twill represents the first signal in the present disclosure.

In Embodiment 8, whether the first control information includes a first field is related to the first signal, the first field is used to indicate whether the first signal is the first positioning reference signal, or the first field is used to indicate a format of the first control information, or the first field is used to indicate the type of the first positioning reference signal.

In one embodiment, the first field comprises a positive integer number of bits.

In one embodiment, the first field is 1 bit.

In one embodiment, the first signal is the first positioning reference signal, and the first control information comprises the first field.

In one embodiment, the first signal is the first data, and the first control information does not comprise the first field.

In one embodiment, the first field is used to indicate whether the first signal is the first positioning reference signal.

In one embodiment, a value of the first field is 1, and the first signal is the first positioning reference signal.

In one embodiment, a value of the first field is 0, and the first signal is the first data.

In one embodiment, a value of the first field is 1, and the first signal is the first positioning reference signal; or, a value of the first field is 0, and the first signal is the first data.

In one embodiment, the first field is used to indicate the type of the first positioning reference signal.

In one embodiment, a value of the first field is 1, and the type of the first positioning reference signal is the first positioning type.

In one embodiment, a value of the first field is 0, and the type of the first positioning reference signal is the second positioning type.

In one embodiment, a value of the first field is 1, and the type of the first positioning reference signal is the first positioning type; or the value of the first domain is 0, and the type of the first positioning reference signal is the second positioning type.

In one embodiment, the first field is used to indicate a format of the first control information.

In one embodiment, a value of the first field is 1, and the format of the first control information is SCI Format 1-B.

In one embodiment, a value of the first field is 0, and the format of the first control information is SCI Format 1-A.

In one embodiment, a value of the first field is 1, and the format of the first control information is SCI Format 1-B; or the value of the first field is 0, and the format of the first control information is SCI Format 1-A.

### Example 9

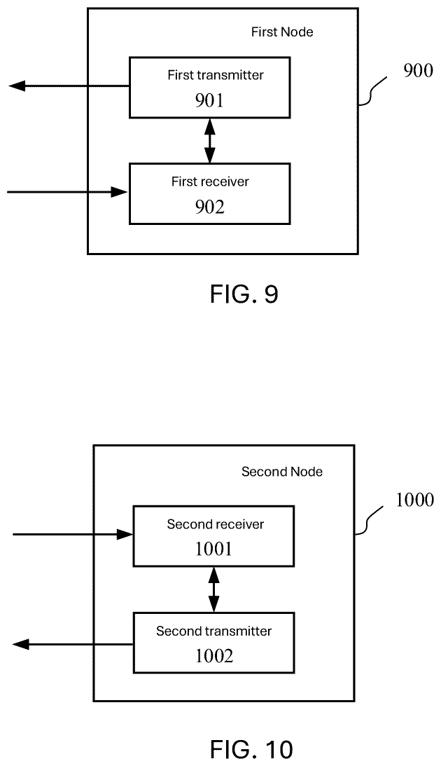

Embodiment 9 illustrates a structural block diagram of a processing apparatus in a first node, as shown in FIG. 9. In Embodiment 9, the first node device processing apparatus 900 is mainly composed of a first transmitter 901 and a first receiver 902.

In one embodiment, the first transmitter 901 comprises at least one of the antenna 452, the transmitter/receiver 454, the multi-antenna transmitter processor 457, the transmitting processor 468, the controller/processor 459, the memory 460, and the data source 467 in FIG. 4 of the present disclosure.

In one embodiment, the first receiver 902 comprises at least one of the antenna 452, the transmitter/receiver 454, the multi-antenna receiving processor 458, the receiving processor 456, the controller/processor 459 and the memory 460 in FIG. 4 of the present disclosure.

In Embodiment 9, the first transmitter 901 sends first control information and a first signal, the first control information includes at least one of a source identifier field and a destination identifier field, the source identifier field is used to indicate the first node, the destination identifier field is used to indicate a target receiver of the first signal, and the first control information is carried on a first PSCCH or a first PSSCH related to the first signal.

In one embodiment, whether the first control information comprises a first field is related to the first signal, the first field is used to indicate that the first signal is a first positioning reference signal, or the first field is used to indicate a format of the first control information.

In one embodiment, whether the first control information is carried on the first PSCCH is related to whether the first signal is a first positioning reference signal.

In one embodiment, the first signal is the first positioning reference signal, and the first control information is carried on the first PSCCH; or the first signal is first data, and the first control information is carried on the first PSSCH.

In one embodiment, the first signal is a first positioning reference signal, whether the first control information is carried on the first PSCCH is related to a type of the first positioning reference signal, and a candidate of the type of the first positioning reference signal comprises a first positioning type and a second positioning type.

In one embodiment, the type of the first positioning reference signal is the first positioning type, and the first control information is carried on the first PSCCH; or the type of the first positioning reference signal is the second positioning type, and the first control information is carried on the first PSSCH.

In one embodiment, the first positioning type and the second positioning type are respectively associated with two different time-frequency maps of the first positioning reference signal.

In one embodiment, the type of the first positioning reference signal is the first positioning type, and a time-frequency resource occupied by the first positioning reference signal and a time-frequency resource occupied by the first control information share a same resource pool; alternatively, the type of the first positioning reference signal is the second positioning type, and a time-frequency resource occupied by the first positioning reference signal and a time-frequency resource occupied by the first control information respectively belong to different resource pools.

In one embodiment, the first receiver 902 receives a second positioning reference signal on a target time-frequency resource block, wherein the type of the first positioning reference signal is the second positioning type, and the first positioning reference signal is associated with the second positioning reference signal.

In one embodiment, whether the first control information indicates that a time-frequency resource occupied by the first signal is related to the first signal.

In one embodiment, the first signal is the first positioning reference signal, and the first control information indicates a time-frequency resource occupied by the first signal; or the first signal is the first data, the first control information is not used to indicate a time-frequency resource occupied by the first signal, and the second control information is used to indicate a time-frequency resource occupied by the first signal.

In one embodiment, the first signal is the first positioning reference signal; the type of the first positioning reference signal is the first positioning type, the first control information indicates a time-frequency resource occupied by the first signal, or the type of the first positioning reference signal is the second positioning type, the first control information is not used to indicate a time-frequency resource occupied by the first signal, and the second control information is used to indicate a time-frequency resource occupied by the first signal. That is,

In one embodiment, the first node 900 is a user equipment.

In one embodiment, the first node 900 is a relay node.

In one embodiment, the first node 900 is a roadside device.

### Example 10

Embodiment 10 illustrates a structural block diagram of a processing device in a second node, as shown in FIG. 10. In Embodiment 10, the second node device processing apparatus 1000 is mainly composed of a second receiver 1001 and a second transmitter 1002.

In one embodiment, the second receiver 1001 comprises at least one of the antenna 420, the transmitter/receiver 418, the multi-antenna receiving processor 472, the receiving processor 470, the controller/processor 475 or the memory 476 in FIG. 4 of the present disclosure.

In one embodiment, the second transmitter 1002 comprises at least one of the antenna 420, the transmitter/receiver 418, the multi-antenna transmitting processor 471, the transmitting processor 416, the controller/processor 475 or the memory 476 in FIG. 4 of the present disclosure.

In Embodiment 10, the second receiver 1001 receives first control information and a first signal, where the first control information includes at least one of a source identifier field and a destination identifier field, the source identifier field is used to indicate the first node, the destination identifier field is used to indicate a target receiver of the first signal, and the first control information is carried on a first PSCCH or a first PSSCH related to the first signal.

In one embodiment, whether the first control information comprises a first field is related to the first signal, the first field is used to indicate that the first signal is a first positioning reference signal, or the first field is used to indicate a format of the first control information.

In one embodiment, whether the first control information is carried on the first PSCCH is related to whether the first signal is a first positioning reference signal.

In one embodiment, the first signal is the first positioning reference signal, and the first control information is carried on the first PSCCH; or the first signal is first data, and the first control information is carried on the first PSSCH.

In one embodiment, the first signal is a first positioning reference signal, whether the first control information is carried on the first PSCCH is related to a type of the first positioning reference signal, and a candidate of the type of the first positioning reference signal comprises a first positioning type and a second positioning type.

In one embodiment, the type of the first positioning reference signal is the first positioning type, and the first control information is carried on the first PSCCH; or the type of the first positioning reference signal is the second positioning type, and the first control information is carried on the first PSSCH.

In one embodiment, the first positioning type and the second positioning type are respectively associated with two different time-frequency maps of the first positioning reference signal.

In one embodiment, the type of the first positioning reference signal is the first positioning type, and a time-frequency resource occupied by the first positioning reference signal and a time-frequency resource occupied by the first control information share a same resource pool; alternatively, the type of the first positioning reference signal is the second positioning type, and a time-frequency resource occupied by the first positioning reference signal and a time-frequency resource occupied by the first control information respectively belong to different resource pools.

In one embodiment, the second transmitter 1002 transmits a second positioning reference signal on a target time-frequency resource block, wherein the type of the first positioning reference signal is the second positioning type, and the first positioning reference signal is associated with the second positioning reference signal.

In one embodiment, whether the first control information indicates that a time-frequency resource occupied by the first signal is related to the first signal.

In one embodiment, the first signal is the first positioning reference signal, and the first control information indicates a time-frequency resource occupied by the first signal; or the first signal is the first data, the first control information is not used to indicate a time-frequency resource occupied by the first signal, and the second control information is used to indicate a time-frequency resource occupied by the first signal.

In one embodiment, the first signal is the first positioning reference signal; the type of the first positioning reference signal is the first positioning type, the first control information indicates a time-frequency resource occupied by the first signal, or the type of the first positioning reference signal is the second positioning type, the first control information is not used to indicate a time-frequency resource occupied by the first signal, and the second control information is used to indicate a time-frequency resource occupied by the first signal.

In one embodiment, the second node 1000 is a user equipment.

In one embodiment, the second node 1000 is a relay node.

In one embodiment, the second node 1000 is a roadside device.

A person of ordinary skill in the art may understand that all or some of the steps in the foregoing method may be completed by instructing related hardware through a program, and the program may be stored in a computer-readable storage medium, for example, a read-only memory, a hard disk, or an optical disk. Optionally, all or some of the steps in the foregoing embodiments may also be implemented by using one or more integrated circuits. Correspondingly, each module unit in the foregoing embodiments may be implemented in a form of hardware, or may be implemented in a form of a software functional module, and the present application is not limited to any specific form of combination of software and hardware. The first node device in this application includes, but is not limited to, a mobile phone, a tablet computer, a notebook, an upper network card, a low-power-consumption device, an eMTC device, an NB-IoT device, a vehicle-mounted communication device, an aircraft, an aircraft, an unmanned aerial vehicle, a remote control aircraft, and other wireless communication devices. The second node device in this application includes, but is not limited to, a mobile phone, a tablet computer, a notebook, an upper network card, a low-power-consumption device, an eMTC device, an NB-IoT device, a vehicle-mounted communication device, an aircraft, an aircraft, an unmanned aerial vehicle, a remote control aircraft, and other wireless communication devices. The user equipment or the UE or the terminal in this application includes but is not limited to a mobile phone, a tablet computer, a notebook, an upper network card, a low-power-consumption device, an eMTC device, an NB-IoT device, a vehicle-mounted communication device, an aircraft, an aircraft, an unmanned aerial vehicle, a remote control aircraft, and other wireless communication devices. The base station device or the base station or the network side device in the present disclosure includes, but is not limited to, a macro cell base station, a micro-cellular base station, a home base station, a relay base station, an EAVE, a graceful, a transmission receiving node TRP, a GNSS, a relay satellite, a satellite base station, an air base station, and other wireless communication devices.

The above are only preferred embodiments of the present disclosure and are not intended to limit the scope of protection of the present disclosure. Any modifications, equivalent replacements, improvements and the like made within the spirit and principle of the present disclosure shall fall within the protection scope of the present disclosure.

1. A first node for wireless communication, comprising:
a first transmitter, configured to send first control information and a first signal;
wherein the first control information includes at least one of a source identifier field and a destination identifier field, the source identifier field indicating the first node, the destination identifier field indicating a target receiver of the first signal, and the first control information is carried on a first Physical Sidelink Control Channel (PSCCH) or a first Physical Sidelink Shared Channel (PSSCH) related to the first signal.

2. The first node according to claim 1, wherein whether the first control information includes a first field is related to the first signal, the first field is used to indicate that the first signal is a first positioning reference signal, or the first field is used to indicate a format of the first control information.

3. The first node according to claim 2, wherein whether the first control information is carried on the first PSCCH is related to whether the first signal is a first positioning reference signal.

4. The first node according to claim 3, wherein the first signal is the first positioning reference signal, and the first control information is carried on the first PSCCH; or the first signal is first data, and the first control information is carried on the first PSSCH.

5. The first node according to claim 2, wherein the first signal is a first positioning reference signal, whether the first control information is carried on the first PSCCH is related to a type of the first positioning reference signal, and a candidate of the type of the first positioning reference signal includes a first positioning type and a second positioning type.

6. The first node according to claim 5, wherein the type of the first positioning reference signal is the first positioning type, and the first control information is carried on the first PSCCH; or the type of the first positioning reference signal is the second positioning type, and the first control information is carried on the first PSSCH.

7. The first node according to claim 6, wherein the first positioning type and the second positioning type are respectively associated with two different time-frequency patterns of the first positioning reference signal.

8. The first node according to claim 7, wherein the type of the first positioning reference signal is the first positioning type, and a time-frequency resource occupied by the first positioning reference signal and a time-frequency resource occupied by the first control information share a same resource pool; alternatively, the type of the first positioning reference signal is the second positioning type, and a time-frequency resource occupied by the first positioning reference signal and a time-frequency resource occupied by the first control information respectively belong to different resource pools.

9. The first node according to claim 8, further comprising:
a first receiver, configured to receive the second positioning reference signal on a target time-frequency resource block; and
wherein the type of the first positioning reference signal is the second positioning type, and the first positioning reference signal is associated with a second positioning reference signal.

10. The first node according to claim 9, wherein the first control information indicates whether a time-frequency resource occupied by the first signal is related to the first signal.

11. The first node according to claim 10, wherein the first signal is the first positioning reference signal, and the first control information indicates a time-frequency resource occupied by the first signal; or the first signal is the first data, the first control information is not used to indicate a time-frequency resource occupied by the first signal, and the second control information is used to indicate a time-frequency resource occupied by the first signal.

12. The first node according to claim 10, wherein the first signal is the first positioning reference signal; the type of the first positioning reference signal is the first positioning type, the first control information indicates a time-frequency resource occupied by the first signal, or the type of the first positioning reference signal is the second positioning type, the first control information is not used to indicate a time-frequency resource occupied by the first signal, and the second control information is used to indicate a time-frequency resource occupied by the first signal.

13-24. (canceled)

25. A method in a first node for wireless communication, comprising:
sending first control information and a first signal;
wherein the first control information includes at least one of a source identifier field and a destination identifier field, the source identifier field is used to indicate the first node, the destination identifier field is used to indicate a target receiver of the first signal, and the first control information is carried on a first Physical Sidelink Control Channel (PSCCH) or a first Physical Sidelink Shared Channel (PSSCH) related to the first signal.

26. The method according to claim 25, wherein whether the first control information includes a first field is related to the first signal, the first field is used to indicate that the first signal is a first positioning reference signal, or the first field is used to indicate a format of the first control information.

27. The method according to claim 26, wherein whether the first control information is carried on the first PSCCH is related to whether the first signal is a first positioning reference signal.

28. The method according to claim 27, wherein the first signal is the first positioning reference signal, and the first control information is carried on the first PSCCH; or the first signal is first data, and the first control information is carried on the first PSSCH.

29. The method according to claim 26, wherein the first signal is a first positioning reference signal, whether the first control information is carried on the first PSCCH is related to a type of the first positioning reference signal, and a candidate of the type of the first positioning reference signal includes a first positioning type and a second positioning type.

30. The method according to claim 29, wherein the type of the first positioning reference signal is the first positioning type, and the first control information is carried on the first PSCCH; or the type of the first positioning reference signal is the second positioning type, and the first control information is carried on the first PSSCH.

31. The method according to claim 30, wherein the first positioning type and the second positioning type are respectively associated with two different time-frequency maps of the first positioning reference signal.

32. The method according to claim 31, wherein the type of the first positioning reference signal is the first positioning type, and a time-frequency resource occupied by the first positioning reference signal and a time-frequency resource occupied by the first control information share a same resource pool; alternatively, the type of the first positioning reference signal is the second positioning type, and a time-frequency resource occupied by the first positioning reference signal and a time-frequency resource occupied by the first control information respectively belong to different resource pools.

33. The method according to claim 32, further comprising:
receiving a second positioning reference signal on a target time-frequency resource block; and
wherein the type of the first positioning reference signal is the second positioning type, and the first positioning reference signal is associated with the second positioning reference signal.

34. The method according to claim 33, wherein the first control information indicates whether a time-frequency resource occupied by the first signal is related to the first signal.

35. The method according to claim 34, wherein the first signal is the first positioning reference signal, and the first control information indicates a time-frequency resource occupied by the first signal; or the first signal is the first data, the first control information is not used to indicate a time-frequency resource occupied by the first signal, and the second control information is used to indicate a time-frequency resource occupied by the first signal.

36. The method according to claim 34, wherein the first signal is the first positioning reference signal; the type of the first positioning reference signal is the first positioning type, the first control information indicates a time-frequency resource occupied by the first signal, or the type of the first positioning reference signal is the second positioning type, the first control information is not used to indicate a time-frequency resource occupied by the first signal, and the second control information is used to indicate a time-frequency resource occupied by the first signal.

37-48. (canceled)
